(19) United States
(12) Patent Application Publication
(10) Pub. No.: US 2026/0255393 A1
(43) Pub. Date: Aug. 27, 2026

(54) DELIVERY TRAFFIC INDICATION MESSAGE (DTIM) GROUPCAST TECHNIQUES IN MULTI-LINK OPERATION (MLO) AND NON-MLO ENVIRONMENTS

(71) Applicant: Cisco Technology, Inc., San Jose, CA (US)

(72) Inventors: Brian D. Hart, Sunnyvale, CA (US); Sachin Dinkar Wakudkar, St-Sulpice (CH); Jegan Manoharan, Bangalore (IN); Pascal Thubert, Roquefort-les-Pins (FR); Jerome Henry, Pittsboro, NC (US)

(21) Appl. No.: 19/366,831

(22) Filed: Oct. 23, 2025

Related U.S. Application Data
(60) Provisional application No. 63/769,226, filed on Mar. 10, 2025.

(30) Foreign Application Priority Data
Feb. 21, 2025 (IN) 202541014883

(51) Int. Cl. H04W 74/0816; H04W 8/22; H04W 52/02

(52) U.S. Cl. CPC H04W 74/0816; H04W 8/22; H04W 52/0261

(57) ABSTRACT

Various Delivery Traffic Indication Message (DTIM) groupcast techniques that may be utilized in multi-link operation (MLO) and non-MLO scenarios for one or more wireless local area networks (WLANs) are provided herein. The techniques can facilitate power saving operations for client devices and/or enhanced Non-Primary Channel Access (NPCA) operations for client devices and AP devices in overlapping basic service set (OBSS) environments.

### PRIORITY CLAIM

This application claims the benefit of priority to Indian Provisional Application No. 202541014883, filed on Feb. 21, 2025, and the benefit of priority under 35 U.S.C. § 119 to U.S. Provisional Application No. 63/769,226, filed on Mar. 10, 2025, the entirety of which applications are incorporated herein by reference.

### TECHNICAL FIELD

The present disclosure relates to wireless networking.

### BACKGROUND

Networking architectures have grown increasingly complex in communications environments, particularly wireless local area network (WLAN) environments. For wireless local area networks, Institute of Electrical and Electronics Engineers (IEEE) 802.11be (Wi-Fi® 7) defines various features to facilitate Multi-Link Operation (MLO) for Multi-Link Devices (MLDs) that are capable of associating and simultaneously exchanging data traffic on multiple Radio Frequency (RF) channels or ‘links’. With MLO, it is possible to increase the throughput for a client device by aggregating traffic across multiple links. The introduction of MLO presents new challenges and opportunities with regard to management of communication services within WLANs.

### BRIEF DESCRIPTION OF THE DRAWINGS

FIG. 1A is a block diagram illustrating a system in which delivery traffic indication message (DTIM) groupcast techniques may be provided for non-multi-link operation (non-MLO) environments, MLO environments, and/or virtual Basic Service Set (BSS) environments, according to various example embodiments.

FIG. 1B is a block diagram illustrating example details for any access point (AP) device that can be provided in the system of FIG. 1A, according to various example embodiments.

FIG. 1C is a block diagram illustrating example details for a client device that may be present in the system of FIG. 1A, according to various example embodiments.

FIG. 2 is a flowchart depicting a method according to an example embodiment.

FIG. 3 is a diagram illustrating example details associated with DTIM groupcast burst transmissions.

FIG. 4 is a diagram illustrating details for an example burst of beacons and DTIM groupcast burst transmission for which one or more groupcast burst duration indications can be provided in accordance with embodiments herein.

FIG. 5 is a schematic diagram illustrating example details for a Physical Layer Protocol Data Unit (PPDU) and a Media Access Control (MAC) frame that can be used to provide one or more burst duration indications associated with a groupcast burst transmission, according to an example embodiment.

FIG. 6 is a schematic diagram illustrating example details for an initial control frame (ICF) that can be used to provide one or more burst duration indications associated with a groupcast burst transmission, according to an example embodiment.

FIG. 7 is a diagram illustrating details for an example burst of beacons and DTIM groupcast burst transmission in relation to enhanced Non-Primary Channel Access (NPCA) operations that may be facilitated through embodiments herein.

FIG. 8 is a flowchart depicting a method according to an example embodiment.

FIG. 9 is a flowchart depicting a method according to an example embodiment.

FIGS. 10A and 10B are diagrams illustrating various mechanisms through which an NPCA opportunity can be signaled by a first AP device to a second AP device and one or more client devices of the second AP device, according to various example embodiments.

FIG. 11 is a schematic diagram illustrating example details for different fields of a beacon frame that can be used to provide an indication of a groupcast burst transmission of a first AP device, thereby signaling an NPCA opportunity, according to an example embodiment.

FIG. 12 is a diagram illustrating example details for a Multi-Access Point Coordination (MAPC) discovery and/or negotiation that can be performed between a first AP device and a second AP device for enhanced NPCA operations, according to an example embodiment.

FIG. 13 is a hardware block diagram of device configured to perform functions associated with operations discussed in connection with embodiments herein.

### DETAILED DESCRIPTION

### Overview

Various Delivery Traffic Indication Message (DTIM) techniques are provided herein that may be utilized in per-link scenarios and multi-link operation (MLO)/multi-link device (MLD) scenarios for wireless local area networks (WLANs). The techniques provided by embodiments herein can facilitate enhanced operations for client devices and access point (AP) devices operating in any combination of multi-link and/or non-multi-link configurations within a particular network (a particular WLAN) and/or between networks (between WLANs). Gains provided by embodiments herein may be enhanced in multiple Basic Service Set (BSS) scenarios where a physical AP radio of an AP device may support multiple virtual BSSs (standalone BSSs or as part of Co-Hosted BSSID sets) or multiple MBSSID sets, each with their own Beacon frame.

In at least one embodiment, techniques herein may assist an MLO client device in saving power during DTIM groupcast bursts on wireless link(s) where the MLO client is not obtaining a groupcast burst transmission, by indicating a behavior that a pure groupcast burst transmission is to occur after beacons and efficiently indicating the length of the groupcast burst, referred to herein as ‘burst duration’ information/indications, so that such MLO clients can spend most of that time in light/deep sleep for the link(s)/radios from which the groupcast burst transmission is not to be retrieved by the MLO clients, thereby minimizing power consumption for the MLO client devices.

Techniques herein may also facilitate enhanced Non-Primary Channel Access (NPCA) operations, which may be useful in overlapping basic service set (OBSS) scenarios and especially in the case of multiple virtual BSSs. In at least one embodiment, burst duration information associated with a DTIM groupcast burst transmission transmitted by a first AP device (AP1) can be used by a second (neighboring/OBSS) AP device (AP2) and its client devices to determine the presence of an (upcoming) DTIM groupcast burst transmission involving a primary channel that is also used by the second AP (APDev2) and its clients. Based on the burst duration information that is obtained by the second AP device/client devices, the second AP device/client devices can switch to an NPCA primary channel to perform NPCA transmissions for an amount of time based on the burst duration information obtained from the first AP device (APDev1).

### Example Embodiments

In a wireless local area network (WLAN) or Wi-Fi® network, one or more wireless APs provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

Innovations in Institute of Electrical and Electronics Engineers (IEEE) 802.11 (Wi-Fi®) standards and amendments thereof, such as 802.11be (typically referred to as Wi-Fi 7) have led to the development of Multi-Link Devices (MLDs) that are capable of Multi-Link Operation (MLO). For MLO, MLDs can associate and simultaneously exchange data traffic on multiple Radio Frequency (RF) bands, such as 2.4 Gigahertz (GHz), 5 GHz, and/or 6 GHz bands.

As referred to herein, a radio (e.g., hardware (HW), such as RF transceiver, baseband processor(s), Media Access Control (MAC) processor(s) and any software (SW)/logic associated therewith) provided for an AP device can be referred to as an ‘AP’, which can be inclusive of a physical radio or a virtual radio (referred to herein as a virtual AP (VAP). As such, an AP device, as referred to herein, can include one or more radios/APs.

Further as referred to herein, a radio for a client device can be referred to as a station (STA) or a non-AP STA, which can be inclusive of a physical radio or a virtual radio (referred to herein as a virtual STA (VSTA). As such, a client device, as referred to herein, can include one or more radios/STAs.

One or more MLDs can be configured for AP devices. An MLD configured for an AP device can be referred to herein as an AP-MLD. One or more MLDs can also be configured for a client device. An MLD configured for a client device can be referred to herein as a STA-MLD or a non-AP-MLD.

An AP-MLD configured for an AP device can be configured to include multiple radios/APs to facilitate MLO for the AP device. In the context of a given AP-MLD configured for a given AP device, the radios/APs configured for the given AP-MLD can be referred to herein as ‘affiliated’ radios/APs (to facilitate MLO).

A STA-MLD configured for a client device can be configured to include multiple radios/STAs to facilitate MLO for the client device. In the context of a given STA-MLD configured for a given client device, the radios/STAs configured for the given STA-MLD can be referred to herein as ‘affiliated’ radios/STAs.

As referred to herein, the terms ‘link’, ‘wireless link’, and variations thereof can be used interchangeably and can refer to a wireless connection through which a radio/STA of a client device can wirelessly connect to/access a wireless connection facilitated by a radio/AP an AP device. A link may include a channel or multiple contiguous channels of a given bandwidth (e.g., 20 Megahertz (MHz), 40 MHz, 80 MHz, 160 MHz, or 320 MHz (and potentially greater for future IEEE 802.11 amendments).

When transmitting Beacons in an IEEE 802.11 wireless network for scenarios involving Delivery Traffic Indication Message (DTIM) groupcast, the exchange for AP transmissions (of an AP device) can be characterized as follows:

<PIFS><BCN-1><SIFS><BCN-2><SIFS>. . .<BCN-N>
<AIFS_VO><MCAST-1><SIFS><MCAST-2>
<SIFS>. . .<MCAST-LAST>

Where PIFS =Priority Interframe Space, SIFS=Short Interframe Space, BCN=Beacon (through N), and MCAST=DTIM groupcast frame (1 through LAST). A TIM element in the Beacons, specifically, a ‘DTIM count’ countdown timer field therein set to a value of 0, indicates the presence of groupcast following the Beacons, then each groupcast frame has a More Data field set to a value of 1 until the last groupcast frame. The terms ‘Beacon’ and ‘Beacon frame’ are used interchangeably herein.

Groupcast after an IEEE 802.11 DTIM Beacon can span an extended duration, such as, for example, up to 50% of a Beacon interval might be composed of groupcast traffic. Moreover, Multicast Domain Name System (mDNS) and other exchanges can be very “chatty” in that they can generate a lot of traffic.

With MLO, groupcast sequence numbers (SNs) are assigned at the MLD level then passed to individual AP radios (e.g., a 2.4 GHz radio, a 5 GHz radio, and a 6 GHz radio of an AP-MLD) for transmission. With MLO, a STA-MLD of a client device typically retrieves its groupcast from one link, referred to herein as the DTIM groupcast link (DGL), and all other links are referred to as non-DGLs. However, APs of an AP-MLD typically transmit groupcast frames (assuming an AP does not or cannot track which clients are interested in the groupcast transmissions or the Power Management Mode of any known-interested client is in a Power Saving (PS) Mode) in groupcast burst transmissions across all its radios (not knowing which affiliated STAs of a STA-MLD have active/associated links with corresponding affiliated APs of the AP-MLD at a given time), such that affiliated STAs of a STA-MLD receive the same groupcast frames in groupcast burst transmissions from affiliated APs of the AP-MLD on all of its active/awake links (links for which the affiliated STAs of the STA-MLD have associated to affiliated APs of the AP-MLD and on which an affiliated STA is not dozing). Thus, although a STA-MLD deliberately receives DTIM groupcast frames in DTIM groupcast burst transmissions from its designated DGL, the non-DGL (also referred to herein as non-designated groupcast links) links also receive the same groupcast frames in DTIM groupcast burst transmissions on its other active links.

As an illustrative example only, consider that a given STA-MLD configured for a given client device includes affiliated STAs, such as a 2.4 GHz STA and a 5 GHZ STA. In this example, the link provided by the 5 GHz affiliated STA (5 GHz link) can set to be the DGL from which groupcast burst transmissions are retrieved by the client device (e.g., by processor(s), logic, etc. configured for the client device) and the link provided by the 2.4 GHz affiliated STA (2.4 GHz link) can be set to the non-NGL.

Given the common SNs, a client device could retrieve groupcast from multiple links (e.g., via 2.4 GHz and 5 GHz links, via 2.4 GHz, 5 GHz, and 6 GHz links, and/or any other combination of links) then de-duplicate any duplicate groupcast data received on multiple links or retrieve some groupcast from one link and other groupcast from the other link. But this is atypical given the desire to save power. Thus, if a client device is in an awake state on two or more links at a time, while a non-DGL link (from an affiliated AP of the AP-MLD) is sending DTIM groupcast traffic, the client device is wasting energy. It is desirable to avoid this situation.

Groupcast is becoming relatively common (e.g., due to mDNS announcements). APs may allow tens of time units (TUs) of groupcast per DTIM transmissions if the groupcast load is offered.

Beacons and DTIM groupcast are typically sent at a 20 MHz bandwidth. In many deployments, AP device density is favored for performance so this bandwidth suffices (rather than non-high throughput (non-HT) duplicate Beacons spanning 40 MHz or higher, for improved sensitivity especially at 6 GHz where the regulations limit the power spectral density).

The first Beacon of a Co-located Basic Service Set Identifier (BSSID) Set is typically sent at PIFS, a time interval that provides priority access to certain frame types, such as Channel Switch Announcement frames. (This is somewhat more than SIFS, which has even higher priority and is used for other frame types such as Acknowledgment (ACK) and Block ACK Request (BAR) frames). Subsequent Beacons are typically sent after a similarly short inter-frame spacing (IFS) known as xIFS. Each Beacon typically does not protect subsequent Beacons (i.e., Duration equals 0).

Each groupcast frame in a Physical Layer Protocol Data Unit (PPDU) is typically transmitted after a short backoff such as the Enhanced Distributed Coordination Access'Arbitration Interframe Space Number (AIFSN)[VO], typically equal to a value of SIFS+2 slot times (which happens to be the same value as the Distributed Interframe Space, which is the IFS used between frames from different devices for the earlier Distributed Coordination Function). Each groupcast frame typically does not protect subsequent groupcast frames (i.e., Duration equals 0) to allow for PIFS-priority frames to be sent in the middle of the burst if needed. The final groupcast frame is sent with End of Service Period (EOSP)=1 so PM=1 (power mode type 1) client devices can revert to sleep upon obtaining their corresponding groupcast traffic.

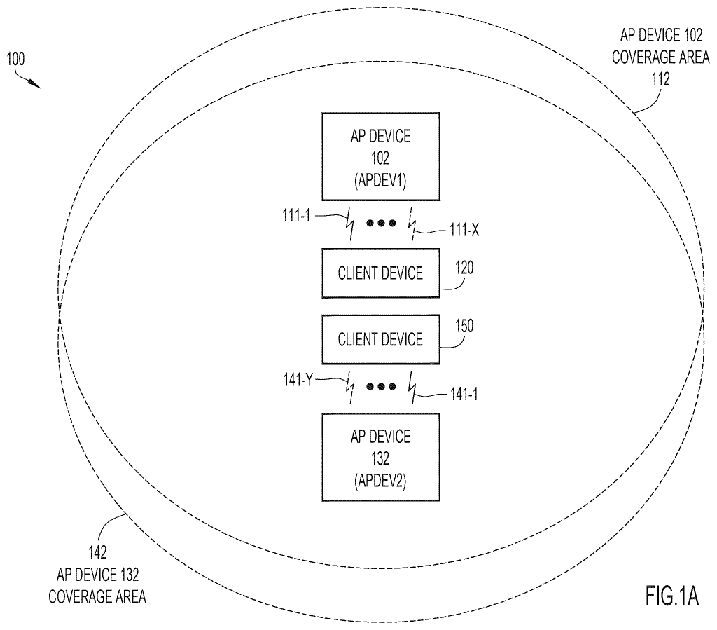

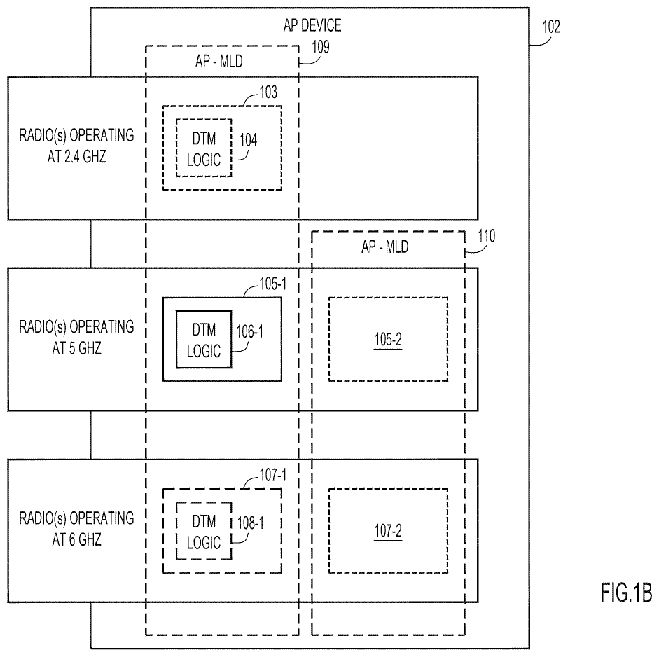

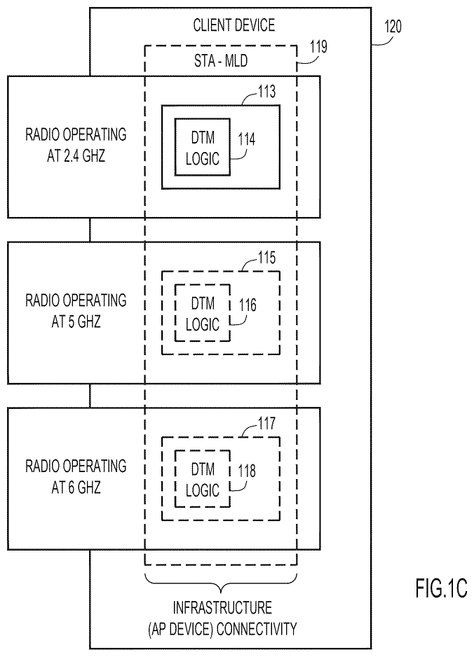

Referring to FIG. 1A, FIG. 1A is a block diagram of a system 100 in which delivery traffic indication message (DTIM) groupcast techniques in non-multi-link operation (MLO) environments, MLO environments and/or multiple virtual Basic Service Set (BSS) environments may be provided, according to various example embodiments. System 100 is discussed herein in relation to both client device power saving operations that may be provided by embodiments herein and also enhanced NPCA operations that may be provided by embodiments herein. FIG. 1B is a block diagram illustrating example details for any AP device that can be provided in system 100 of FIG. 1A, according to various example embodiments. FIG. 1C is a block diagram illustrating example details for any client device that may be present in system 100 of FIG. 1A, according to various example embodiments.

In at least one embodiment, system 100 may include one or more AP devices, such as an AP device 102 and an AP device 132. AP device 102 may be referred to herein as ‘APDev1’ for various operations/embodiments discussed herein (e.g., with reference to various enhanced NPCA operations/embodiments). AP device 132 may be referred to herein as ‘APDev2’ for various operations/embodiments discussed herein (e.g., with reference to various enhanced NPCA operations/embodiments). Also shown in FIG. 1A are a client device 120 and a client device 150.

Turning to FIG. 1B, consider various example details for AP devices that can be provided for system 100, such as AP device 102, in accordance with various embodiments. Although only AP device 102 is discussed for FIG. 1B, it is to be understood that any AP device provided for system 100, such as AP device 132, can be configured with/provide similar features as discussed with reference to AP device 102.

Broadly, AP device 102 can include any WLAN/802.11 hardware and/or software and/or logic and/or the like (sometimes called a modem or radio(s)) to perform medium access control, baseband signal processing (such as modulation/demodulation), and RF (such has transceivers and antenna assemblies (not shown)), and/or the like) to facilitate signal transmissions and signal receptions and thence WLAN RF coverage (for any WLAN/802.11 variant, such as 802.11ax (Wi-Fi 6/6E), 802.11be (Wi-Fi 7), 802.11bn (Wi-Fi 8), etc.) for system 100. Although not shown in FIG. 1A, in at least one embodiment, a wireless network controller (sometimes referred to as a wireless LAN controller (WLC) can be included in system 100 to facilitate control/management of AP device 102.

A number of radio(s)/AP(s) can be configured for AP device 102. In at least one embodiment, AP device 102 can include zero or at least one radio/AP operating at 2.4 GHz, such as an AP 103. AP 103 can be configured with DTIM logic 104 that can facilitate various operations as discussed for embodiments herein. A 2.4 GHz radio, such as AP 103, provided for AP device 102 can be inclusive of an AP, an IEEE AP, and/or one or more VAP(s) to provide standalone (IEEE) (V)APs (virtual/non-virtual), a Multiple Basic Service Set Identifier (MBSSID) set, a co-hosted BSSID set, and/or an AP set that can be enabled by the HW/SW of the 2.4 GHz radio.

In at least one embodiment, AP device 102 can include 1 or 2 radio(s)/AP(s) operating at 5 GHz, such as an AP 105-1 and potentially an AP 105-2, each of which can be configured with DTIM logic that can facilitate various operations as discussed for embodiments herein. For example, DTIM logic 106-1 is shown for AP 105-1. A 5 GHz radio, such as AP 105-1 and/or 105-2, provided for AP device 102 can be inclusive of an AP, an IEEE AP, and/or one or more VAP(s) to provide standalone (IEEE) (V)APs, a MBSSID set, a co-hosted BSSID set, and/or an AP set that can be enabled by the HW/SW of the 5 GHz radio.

In at least one embodiment, AP device 102 can include zero, 1, or 2 radio(s)/AP(s) operating at 6 GHz, such as an AP 107-1 and potentially an AP 107-2, each of which can be configured with DTIM logic that can facilitate various operations as discussed for embodiments herein. For example, DTIM logic 108-1 is shown for AP 107-1. A 6 GHz radio, such as AP 105-1 and/or 105-2, provided for AP device 102 can be inclusive of an AP, an IEEE AP, and/or one or more VAP(s) to provide standalone (IEEE) (V)APs, a MBSSID set, a co-hosted BSSID set, and/or an AP set that can be enabled by the HW/SW of the 6 GHz radio.

Two or more APs of an AP device can be affiliated together to provide an MLD for the AP device. In at least one embodiment, AP 103 (2.4 GHz), AP 105-1 (5 GHz), and AP 107-1 (6 GHz) can be affiliated APs for an AP-MLD 109 configured for AP device 102. In at least one embodiment, AP 105-2 (5 GHz) and AP 107-2 (6 GHz) can be affiliated APs for an AP-MLD 110 configured for AP device 102. However, it is to be understood that in some embodiments one or more APs configured for AP device 102 may be configured as standalone AP(s), that is, not configured to be affiliated for an MLD of AP device 102.

For instances in which virtual APs (VAPs) are affiliated, a virtual MLD (VMLD) can be provided for an AP device. The example MLDs illustrated for AP device 102 are shown for example purposes only to illustrate than any combination of APs can be affiliated to provide an AP-MLD for a given AP device.

Turning to FIG. 1C, consider various example details for client devices that can be present in system 100, such as client device 120, in accordance with various embodiments. Although only client device 120 is discussed for FIG. 1C, it is to be understood that any client device for system 100, such as client device 150, can be configured with/provide similar features as discussed with reference to client device 120. Broadly, a client device, such as client device 120, may be inclusive of any wireless device and may be considered any electronic device, etc. that initiates a connection or communication session with a corresponding network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a cellular/WLAN enabled device, and/or any other device, component, element, or object capable of performing wireless voice, audio, video, media, or data exchanges within a system. Thus, a client device may include any hardware and/or software/logic and or the like (sometimes called a modem or radio(s)) to perform medium access control, baseband signal processing (such as modulation/demodulation), and RF (such has transceivers and antenna assemblies (not shown)), and/or the like) to facilitate signal transmissions and signal receptions and thence WLAN RF coverage (for any WLAN/ 802.11 variant, such as 802.11ax (Wi-Fi 6/6E), 802.11be (Wi-Fi 7), 802.11bn (Wi-Fi 8), etc.)

A number of radio(s)/STA(s) can be configured for client device 120 that can be configured to tune to any combination of 2.4 GHz, 5 GHz, and/or 6 GHz to facilitate any combination of infrastructure connectivity, that is, connectivity with a given AP device, and/or peer-to-peer (P2P) connectivity. P2P connectivity may be characterized hotspot or similar connectivity in which client device 120 may be considered to be an AP device, sometimes referred Group Owner for multiple P2P client devices or a soft AP. Radio(s)/STA(s) configured to facilitate infrastructure connectivity for client device 120 are shown in FIG. 1C.

In at least one embodiment, client device 120 can include a radio/STA operating at 2.4 GHz, such as a STA 113 that can be configured with DTIM logic 114 that can facilitate various operations as discussed for embodiments herein. In at least one embodiment, client device 120 can include a radio/STA operating at 5 GHz, such as a STA 115 that can be configured with DTIM logic 116 that can facilitate various operations as discussed for embodiments herein. In at least one embodiment, client device 120 can include a radio/STA operating at 6 GHz, such as a STA 117 that can be configured with DTIM logic 118 that can facilitate various operations as discussed for embodiments herein.

Two or more STAs of client device can be affiliated together to provide an MLD for the client device. In at least one embodiment, STA 113 (2.4 GHz), STA 115 (5 GHz), and STA 117 (6 GHz) can be affiliated STAs for a STA-MLD 119 configured for AP device 102. However, it is to be understood that in some embodiments one or more STAs configured for client device 120 may be configured as standalone STA(s), that is, not configured to be affiliated for an MLD of client device 120.

For instances in which virtual APs (VSTAs) are affiliated, a virtual MLD (VMLD) can be provided for a client device. The example MLD illustrated for client device 120 is shown for example purposes only to illustrate that any combination of STAs can be affiliated to provide an STA-MLD for a given client device for any combination of infrastructure and/or P2P connectivity.

Returning to FIG. 1A, for MLO, MLDs can associate and simultaneously exchange data/traffic on multiple channels across multiple RF bands, such as 2.4 GHz, 5 GHz, and/or 6 GHz bands. Generally, AP device 102 (that is, APs of AP device 102) may provide an RF coverage area 112 within which one or more client devices can associate to/connect to one AP (and perhaps at least one AP) or one or more affiliated APs of one or more AP-MLDs of AP device 102 for various communication exchanges. Similarly, AP device 132 (that is, APs of AP device 132) may provide an RF coverage area 142 within which one or more client devices can associate to/connect to one AP (and perhaps at least one AP) of or one or more affiliated APs of one or more AP-MLDs of AP device 132 for various communication exchanges.

For various client device power saving features that may be provided in accordance with embodiments herein, consider in at least one embodiment that at least two affiliated STAs of a STA-MLD of client device 120 (e.g., at least two of STA 113, STA 115, and STA 117 for STA-MLD 119) are considered to be associated to/connected to at least two affiliated APs of an AP-MLD of AP device 102 (e.g., at least two of AP 103, AP 105-1, and AP 107-1 for AP-MLD 109) such that client device 120 and AP device 102 can communicate across multiple wireless links (links) 111-1 to 111-X simultaneously.

In at least one embodiment, at least two affiliated STAs of a STA-MLD of client device 150 may be associated to/connected to at least two affiliated APs of an AP-MLD of AP device 132 such that client device 150 and AP device 132 can communicate across multiple wireless links (links) 141-1 to 141-Y simultaneously. FIG. 1A illustrates an overlapping BSS (OBSS) scenario in which the coverage area 112 of AP device 102 overlaps with the coverage area 142 AP device 132, the OBSS scenario is discussed in more detail below with regard to various enhanced NPCA operations that can be provided in accordance with embodiments herein.

### Client Device Power Saving Operations

Embodiments herein may facilitate power saving operations for MLO client devices operating based on determining the duration of a burst of beacon(s) and groupcast transmission (which can include multiple transmissions), also referred to herein interchangeably as a burst of beacons groupcast (BBG) transmission (BBG transmission), a groupcast burst transmission, or a groupcast transmission.

As noted above, for MLO, a client device typically retrieves its groupcast data from one link (one affiliated STA of a STA-MLD configured for the client device), referred to herein as the DTIM groupcast link (DGL) (generally, a groupcast link) with all other link(s) of the client device (all other affiliated STA(s) of the STA-MLD) from which groupcast is not retrieved being referred to as non-DGLs (generally, non-DTIM-groupcast links) for that client device/STA-MLD.

However, as noted above, an AP device transmit groupcast burst transmissions across all its radios/affiliated APs of a given AP-MLD configured for the AP device (not knowing which affiliated STAs of client device(s) have active/associated links with the affiliated APs of the AP-MLD at a given time), such that a MLO client device receives the same groupcast burst transmission from the MLO AP device on all of its active/awake links (links for which the affiliated STAs of the STA-MLD have associated to the affiliated APs of the AP-MLD and are not dozing). Thus, although an MLO client device retrieves a DTIM groupcast burst transmission from its designated DGL, the non-DGL links (non-designated groupcast links) also receive the same DTIM groupcast burst transmission. Embodiments herein provide techniques that enable an MLO client device to cause its non-DGL link(s) (affiliated radio(s)) to enter a sleep mode or state, sometimes referred to as doze/dozing state, for one or more periods of time during one or more DTIM groupcast burst transmissions (BBG transmissions).

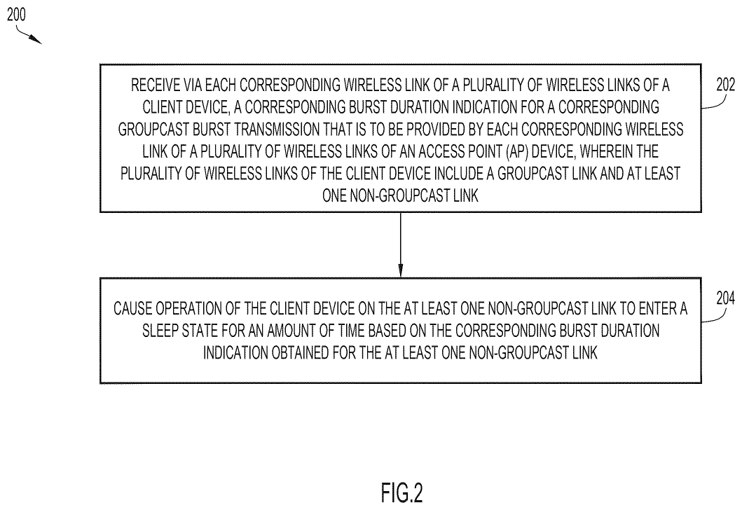

Referring to FIG. 2, FIG. 2 is a flowchart depicting a method 200 according to an example embodiment. In at least one embodiment, operations for method 200 may be performed by a client device such as client device 120 and/or client device 150 of FIG. 1A to facilitate power saving operations for one or more non-DGLs, specifically, non-DGL radios of the client device.

As shown at 202, the method may include receiving via each corresponding wireless link of a plurality of wireless links of a client device, a corresponding burst duration indication for a corresponding groupcast burst transmission that is to be provided by each corresponding wireless link of a plurality of wireless links of an access point (AP) device, wherein the plurality of wireless links of the client device include a groupcast link and at least one non-groupcast link. Each corresponding wireless link of the plurality of wireless links of the client device can receive a different corresponding groupcast burst duration indication and a same corresponding groupcast burst transmission.

As shown at 204, the method may include causing operation of the client device on the at least one non-groupcast link to enter a sleep state for an amount of time based on the corresponding burst duration indication obtained for the at least one non-groupcast link.

In at least one embodiment, causing operation of the client device on the at least one non-groupcast link to enter the sleep state for the amount of time based on the corresponding burst duration indication includes causing at least one radio of the plurality of radios to enter the sleep state in which the at least one radio facilitates the at least one non-groupcast link. In at least one embodiment, the sleep state can include a light sleep state. In at least one embodiment, the sleep state can include a deep sleep state.

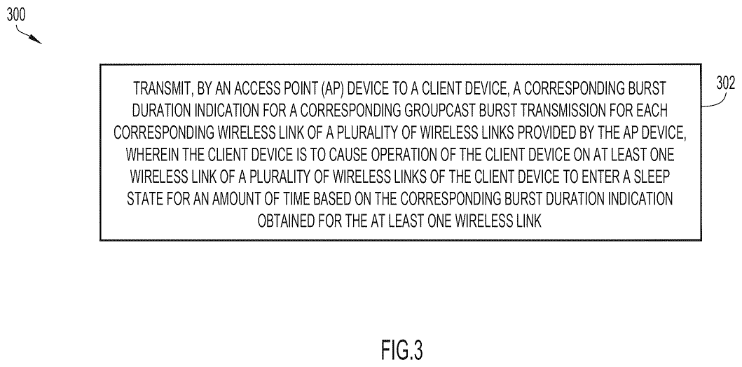

Referring to FIG. 3, FIG. 3 is a flowchart depicting a method 300 according to an example embodiment. In at least one embodiment, operations for method 300 may be performed by an AP-MLD.

As shown at 302, the method may include transmitting, by an access point (AP) device to a client device, a corresponding burst duration indication for a corresponding groupcast burst transmission for each corresponding wireless link of a plurality of wireless links provided by the AP device, wherein the client device is to cause operation of the client device on at least one wireless link of a plurality of wireless links of the client device to enter a sleep state for an amount of time based on the corresponding burst duration indication obtained for the at least one wireless link. The at least one wireless link of the client device can be at least one non-groupcast link for the client device.

In at least one embodiment, causing operation of the client device on the at least one wireless link of the plurality of wireless links of the client device to enter the sleep state for the amount of time based on the at least one burst duration indication obtained for the at least one wireless link includes causing at least one radio of a plurality of radios for the client device to enter the sleep state.

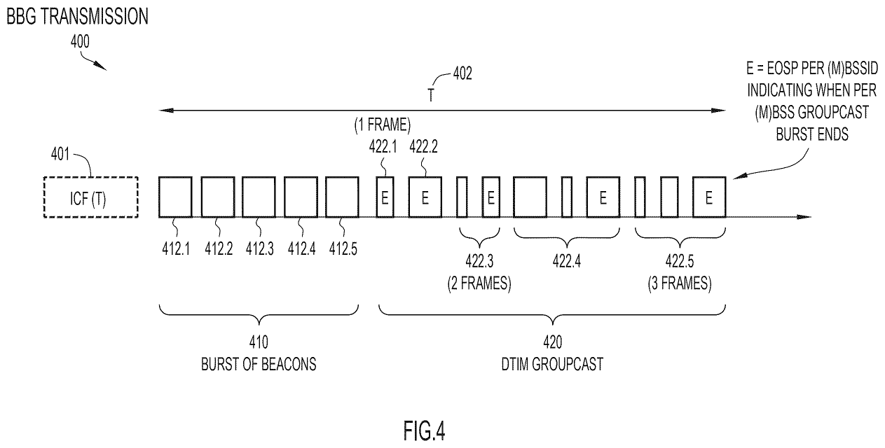

FIG. 4 is a diagram illustrating details for an example burst of beacons and DTIM groupcast burst transmission, referred to herein as a BBG transmission 400, for which one or more groupcast burst transmissions can be provided in accordance with embodiments herein.

A duration of the BBG transmission 400 is ‘T’, as shown at 402, which can be calculated by an AP device and can include a number of MAC frames (e.g., beacon frames and DTIM groupcast frames). DTIM groupcast frames are also referred to herein interchangeably as groupcast frames.

The BBG transmission 400 can include a burst of beacons 410 that, in this example, includes Beacon frames 412.1-412.5. Each Beacon frame can be one Beacon frame per BSSID or can be one Beacon frame per multiple BSSID (MBSSID) (typically for 6 GHz). An MBSSID Beacon frame can provide information for multiple BSSIDs.

The BBG transmission 400 can include a DTIM groupcast burst transmission 420 that, in this example, includes a number of (zero or more) groupcast bursts in which each groupcast burst (groupcast data) (which might be empty or non-empty) corresponds to an (MBSSID) Beacon of the burst of beacons 410, as follows:
422.1—groupcast burst (data) corresponding to Beacon frame 412.1 for a duration of one (1) groupcast frame.
422.2—groupcast burst (data) corresponding to Beacon frame 412.2 for a duration of one (1) groupcast frame.
422.3—groupcast burst (data) corresponding to Beacon frame 412.3 covering a duration of 2 groupcast frames.
422.4—groupcast burst (data) corresponding to Beacon frame 412.4 covering a duration of 3 groupcast frames.
422.5—groupcast burst (data) corresponding to Beacon frame 412.4 covering a duration of 3 groupcast frames.
‘E’ is End of Service Period (EOSP) per (M)BSSID: the final DTIM groupcast frame of each per (M)BSS groupcast burst includes an EOSP indication. The EOSP indication can be used by PM=1 STA-MLDs that are receiving groupcast data for a given (M)BSS burst to go back to sleep on their DGL (groupcast link). If there is no groupcast related to a Beacon at a given Beacon transmission, the EOSP indication can be included in the Beacon itself or a short frame (such as a QoS Null frame) can carry the EOSP field instead.

In accordance with embodiments herein, one or more groupcast burst duration indications can be provided within one or more Beacon frames, within one or more DTIM groupcast frames, and/or within one or more initial control frames (ICFs). FIG. 4 illustrates an ICF 401 that can be transmitted immediately preceding the first Beacon frame 412.1 of BBG transmission 400. Groupcast burst duration indications can be used for client device power saving features as provided by embodiments herein and/or can be used for enhanced NPCA features as provided by embodiments herein.

An affiliated AP of an AP-MLD configured for an AP device knows exactly how many frames, their lengths, modulation and coding schemes (MCSs), and inter-PPDU spacing (xIFS) for a BBG transmission that it is about to transmit (via affiliated APs of the AP-MLD). That is, the AP device knows the minimum duration of each BBG that it is about to transmit (T, 402, as shown in FIG. 4) via a given affiliated AP of an AP-MLD. Although known by the affiliated AP, the BBG duration is not conventionally signaled by affiliated AP.

In at least one embodiment, a given WLAN can be deployed such that (IEEE 802.11bn-capable) AP devices can be provisioned to provide one or more groupcast burst duration indications for each BBG transmission via affiliated APs, such that a client device or, more specifically, affiliated STAs of a corresponding STA-MLD of the client device can parse and interpret such duration indication(s) and may act upon them.

In at least one embodiment, a given WLAN can be deployed such (IEEE 802.11bn-capable) AP devices within the WLAN can be provisioned to provide a capability indication that indicates whether a given AP device will provide one or more groupcast duration indications for each BBG transmission, such that client devices can parse and interpret the capability indication in order to further parse and interpret burst duration indication(s) and act upon them.

Consider various embodiments through which one or more burst duration indications can be determined and signaled by a given AP device, such as AP device 102 (via an affiliated AP of the AP device), to one or more client devices (to an affiliated STA of the client device), such as client device 120. The embodiments can be combined in any manner.
Embodiment 1:
   i. Precompute the duration of a burst of DTIM groupcast frame(s) for a BSS (e.g., 422.4, for example, including 3 DTIM groupcast frames).
   ii. Where defense against a denial of service attack is not needed/desired and the burst of DTIM groupcast frames fit within the maximum signalable burst duration or if the burst of DTIM groupcast frames fit within a transmit opportunity (TXOP)-related duration such as the maximum TXOP duration (or in more limited circumstances), then signal a burst duration indication of the burst of DTIM groupcast frame(s) (typically separated by SIFS) via a Duration field of the MAC header of the first groupcast frame (and potentially only groupcast frame, e.g., for groupcast burst 422.1) of a given burst of groupcast frame(s) then decrement as usual for any remaining groupcast frame(s) of the BSS.
   iii. Otherwise, if the groupcast burst exceeds the maximum TXOP duration or the maximum signalable TXOP duration, break up the DTIM groupcast burst for the BSS into multiple TXOPs, each separated by an AIFS_VO, but continue to set the More Data field in each DTIM groupcast frame to ‘1’ until the final DTIM groupcast frame of the groupcast frames of the BSS. The Duration field might span each TXOP as usual, or somewhat longer, such as SIFS longer (TXOP chaining), PIFS longer, IFS[VO] longer or even a lot longer (e.g., covering the current burst of SIFS-separated DTIM groupcast frames plus the next burst of SIFS-separated DTIM groupcast frames).
Embodiment 2
   i. Precompute the duration of a burst of DTIM groupcast frame(s) of all BSSs (e.g., time after initial ICF 401 (i.e., xIFS after the ICF 401 plus T, 402; T, 402, minus the duration of 412.1 including the multiple other Beacons and DTIM groupcast frames; and/or T, 402, minus the sum of the durations of 412.1, 412.2 and the intervening xIFS).
   ii. Where defense against a denial of service attack is not needed/desired and the burst of DTIM groupcast frames of all BSSs fit within the maximum signalable burst duration or if the burst of DTIM groupcast frames of all BSSs fit within a TXOP-related duration such as the maximum transmit opportunity (TXOP) duration (or in more limited circumstances), then signal the remaining duration of the burst of DTIM groupcast frame(s) of all BSSs. In at least one embodiment, this field could be a compact 7-bit field (e.g., following the definition of the TXOP field in an HE-SIG-A field of a PHY header of a first Physical Layer Protocol Data Unit (PPDU)) or less so (e.g., a burst duration in units of 1 or 8 or 16 microseconds (μsec), rounded down, as a 16/12/11 bit field, respectively). If an ICF is sent, this signaling might be in a Burst Duration field (that is not the Duration field of the ICF). If an ICF is not sent, a burst duration field might be as a field, optionally in an element, in each Beacon in the burst (and that is not the Duration field in the MAC header of each Beacon frame). By not using the Duration field of the MAC header of, say, the first groupcast frame (and potentially only groupcast frame, e.g., for groupcast burst 422.1) of a given burst of groupcast frame(s), undesirable side-effects can be avoided. Such undesirable side-effects may include scenarios in which a client device, operating on its DGL link, associated to an AP-MLD of an affiliated VAP sending the second Beacon, sees the first transmitting beacon which appears to start a long TXOP for that BSS and so is triggered to doze for that signaled Duration field and then misses its desired beacon and groupcast frames.
   iii. Otherwise, break up the DTIM groupcast burst into multiple sub-bursts (although typically all the beacons are kept in one sub-burst) each separated by an AIFS_VO, with the burst duration field in an ICF, a Beacon frame or first PPDU set to the corresponding sub-burst duration and continue to set the More Data field in each DTIM groupcast frame of a BSS to ‘1’ regardless of sub-burst until the final DTIM groupcast frame of the BSS. The burst duration field might be set to a value spanning each sub-burst as usual, or somewhat longer, such as SIFS longer (TXOP chaining), PIFS longer, AIFS[VO] longer, or even a lot longer (e.g., covering the current sub-burst of tightly-packed DTIM groupcast frames plus some amount into the next sub-burst of tightly-packed DTIM groupcast frames).
Embodiment 3
   i. Follow Embodiment 1 and also:
   ii. Where HE is permitted for groupcast (e.g., 6 GHz), apply steps (ii) and (iii) from Embodiment 1 to the TXOP field in the HE-SIG-A field of a PHY header of a given PPDU.

In accordance with embodiments herein, a burst duration indication can broadly correspond to any of: a remaining duration of one or more beacon frames and zero or more groupcast frames of a BBG transmission (if signaled in an ICF preceding the BBG transmission); or a remaining duration of a particular groupcast frame. In various embodiments, a burst duration indication can identify or correspond to an amount of time of any duration/remaining duration discussed for any embodiments herein.

On one or more non-DGLs for a STA-MLD (also receiving a BBG transmission), the client device can discern burst duration indication(s) from any signaling as discussed for embodiments herein that one or more of embodiments 1-3 are being performed by an affiliated AP of an AP-MLD of an AP device. Upon determining such and checking the TIM element (i.e., check to see if the ‘DTIM count’ countdown timer field is set to 0) to see if any DTIM groupcast data is being sent an affiliated STA for the client device can extract duration information (one or more burst duration indication(s)) from a burst duration field of an ICF/a Beacon frame/a first frame in the first (and perhaps only) DTIM groupcast burst/a HE-SIG-A field of the a first PPDU (if present), and then go into light/deep sleep (on the non-DGL radio(s)) until the end of that indicated burst duration (or slightly less or up to SIFS/AIFS more).

If the signaling of the groupcast duration assuredly covers an entire DTIM groupcast burst, then the client device's special activity is complete. Otherwise, the client device can check if the next frame is an ICF carrying a burst duration field or a DTIM groupcast frame and, if so, repeat any of the above to: extract the burst duration information from the corresponding signaling and go to light/deep sleep until the end of that indicated burst duration (or slightly less or up to SIFS/AIFS more). In another variant, the client device might wake-up non-DGL radio(s) before the end of the TXOP to see if the More Data bit is set in the final frames.

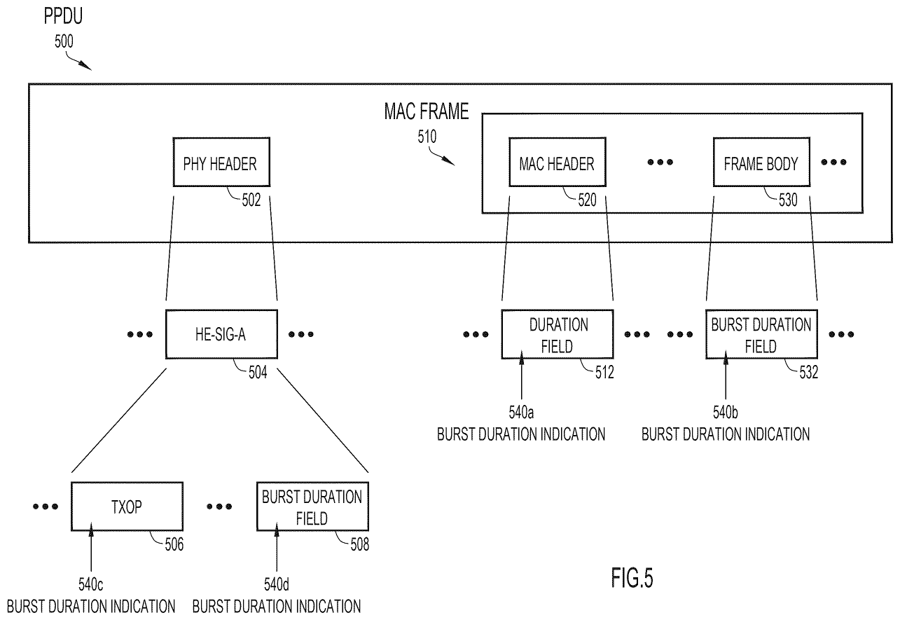

Referring to FIG. 5, FIG. 5 is a diagram illustrating example details for a PPDU 500 that can be used to provide one or more duration indications associated with a groupcast burst transmission, according to an example embodiment. The PPDU 500 comprises various portions and fields, but of relevance to the techniques presented herein, the PPDU 500 is shown to include a physical layer (PHY) header 502 and a MAC frame 510 that can include, a MAC header 520 and a frame body 530.

MAC frame 510 is representative of the frame format for both Beacon frames and DTIM groupcast frames as discussed for embodiments herein.

The MAC header 520 comprises various fields, but of relevance to the techniques presented herein, the MAC header includes a Duration field 512, which can be used to carry a burst duration indication 540a associated with a groupcast burst transmission for Beacon frames or DTIM groupcast frames that may be determined by an affiliated AP of an AP-MLD of an AP device, as discussed above with reference to embodiments 1 and 3, and/or any other embodiments as may be provided herein. The frame body 530 comprises various fields, but of relevance to the techniques presented herein, a burst duration field 532 can be provided in the frame body 530 that can carry a burst duration indication 540b that may be determined by an affiliated AP of an AP-MLD of an AP device, as discussed above with reference to embodiment 2 (e.g., the burst duration field 532 can be provided in the frame body of at least one Beacon frame)..

Turning to the PHY header 502, the PHY header 502 of the PPDU 500 can include various fields, but of relevance to the techniques presented herein, the PHY header 502 includes an HE-SIG-A field 504. The HE-SIG-A field 504 can include various fields, but of relevance to the techniques presented herein, the HE-SIG-A field 504 includes a TXOP field 506 that can be enhanced to carry a burst duration indication 540c that may be determined by an affiliated AP of an AP-MLD of an AP device, as discussed above with reference to embodiment 3. In at least one embodiment, the HE-SIG-A field 504 can be enhanced to include a burst duration field 508 that can be provided after the TXOP field 506 in which the burst duration field 508 can be used to carry a burst duration indication 540d that may be determined by an affiliated AP of an AP-MLD of an AP device, as discussed above with reference to embodiment 2.

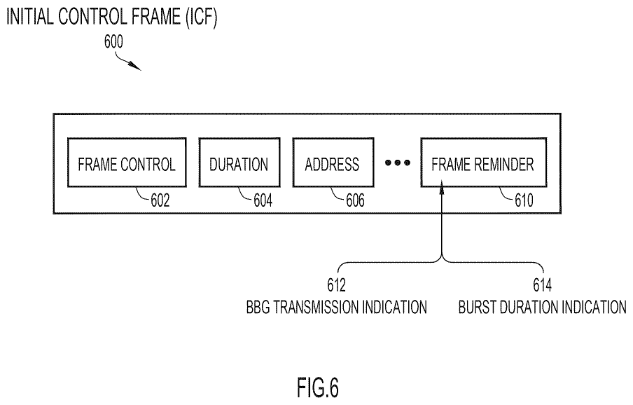

Referring to FIG. 6, FIG. 6 is a schematic diagram illustrating example details for an initial control frame (ICF) 600 that can be used to provide one or more burst duration indications associated with a groupcast burst transmission, according to an example embodiment.

In at least one embodiment, the format of ICF 600 can follow the broadcast Multi-STA BlockAck frame format (e.g., as defined in subclause 9.3.1.8.6 of 802.11-REVme/D7.0, August 2024) or the Buffer Status Report Poll (BSRP) frame format.

In at least one embodiment, ICF 600 can include a Frame Control field 602, a Duration field 604, an Address field 606, and one or more remaining fields, shown in FIG. 6 as Frame Remainder 610. In at least one embodiment, one of more fields of the Frame Remainder 610 can be configured to carry a BBG transmission indication 612 (e.g., to signal that remaining frames correspond to a BBG transmission) and a burst duration indication 614.

With reference to the Multi-STA BlockAck frame format regarding the One Per AID (Association ID) TID (Traffic ID) Info field, various encodings can be provided, such as:
Ack Type=to 0, TID=a reserved TBD (to be determined) value, AID11=reserved TBD value;
If the starting Sequence Number field and Block Ack Bitmap are available, the Frame Remainder can be enhanced to carry:
   A Presence bitfield, with one bit assigned to “Beacon +Groupcast Duration”; and
   A number of bits (e.g., 3-10) that indicate the rounded-down duration of the BBG transmission (burst duration indication).

Various encodings are possible for indicating a burst duration indication for power saving operations or for signaling an NPCA opportunity (discussed below) in accordance with embodiments herein via ICF frame(s), via beacon/groupcast frames, or a PPDU, including but not limited to:
Units of 1/4/8/32/64/128μsec or more, such as ceil(log2(50 TU/128 μsec))=9 bits (for TU =1024 microseconds). Piecewise-linear variants are also possible, such as, in a TXOP field, for example, with pieces incrementing at ~4 μsec then ~64 μsec) using 7 bits but limited to 8575 μsec. A 9-bit version of this encoding scheme could cover up to 33151 μsec.
Power of two versions may be better suited to an Extended Capabilities field or element (as discussed below with reference to various NPCA embodiments), such as 0.25, 0.5, 1, 2, 4, 8, 16, 32 TUs using 3 bits.
All encodings may use rounding down.
An example encoding may be defined similar to the TXOP_DURATION parameter, which is an integer value that can be set to a value less than 127 to indicate burst duration information for a Network Allocation Vector (NAV) setting and protection of the TXOP, as follows:
   If the TXVECTOR parameter TXOP_DURATION is less than 512, set to 2×[TXOP_DURATION/8].
   Otherwise, set to 2×[(TXOP_DURATION—512)/128]+1.

Other burst duration encodings can be envisioned in accordance with embodiments herein. Accordingly, the power saving-related features as provided by embodiments herein can facilitate power savings for scenarios in which an AP device has an AP-MLD configured therefore with a given client device being associated/connected thereto via affiliated STAs of a STA-MLD. More value may be added when there are multiple beacons per AP/radio (e.g., an AP device with a co-hosted BSSID set or multiple MBSSIDs on more than one AP/radio) and/or a lot of groupcast to transmit.

### Enhanced NPCA Operations

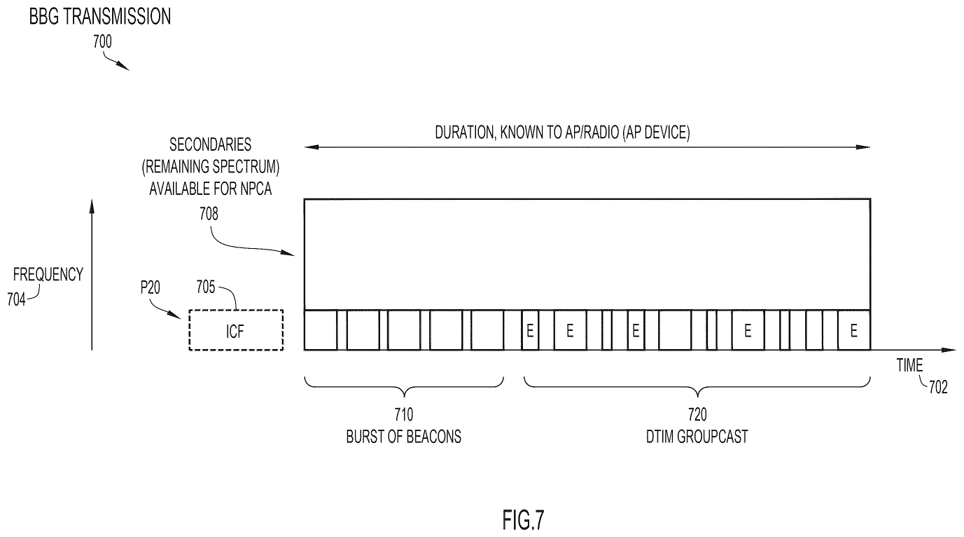

Referring to FIG. 7, FIG. 7 is a diagram illustrating details for an example BBG transmission 700 in relation to enhanced NPCA operations that may be facilitated in accordance with embodiments herein. A burst of beacons 710 and a DTIM groupcast 720 transmission are shown for BBG transmission 700 in which a duration of the transmission is shown in relation to a time axis 702 and a frequency axis 704. In at least one embodiment, transmission of an ICF 705 can be provided immediately before a first Beacon of the burst of beacons 710, in accordance with embodiments herein.

IEEE 802.11bn TGbn (Ultra High Reliability) defines a mode of operation referred to as NPCA that enables a client device to access/transmit/receive data via a secondary channel while the primary channel is known to be busy due to OBSS traffic or other conditions. The secondary channel is often referred to as an NPCA primary channel. An event that triggers switching to the NPCA primary channel may include:
OBSS control frame exchange (such as multi-user (MU-) Request-to-Send/Clear-to-Send (RTS/CTS); or
OBSS High Efficiency/Extremely High Throughput/Ultra High Reliability (HE/EHT/UHR) Physical Layer Protocol Data Unit (PPDU); or
Other conditions.

Bursts of Beacon and DTIM groupcast traffic (BBG transmissions) are prime opportunities for NPCA operation. That is, the period of time in which a BBG transmission is occurring for a primary channel of an OBSS AP-MLD and its STA-MLD clients (in which the BBG transmission is being performed by a neighboring OBSS AP-MLD, thereby occupying the primary channel) represents a period in which it may be advantageous to switch to the NPCA primary channel to continue to communicate.

Multiple Service Set Identifiers (SSIDs) are common in enterprise deployments (and also now in non-enterprise/residential/home deployments) to support clients with credentials for different networks/different security capabilities/different levels of criticality, etc. At an AP/radio of an AP device, each SSID is enabled via either its own Beacon frame or by a transmitted or non-transmitted profile within a shared Beacon (known as an MBSSID beacon). Beacons can contain multiple hundreds (and exceed 1000) of octets and thus can last 0.5-1 msec at low modulation coding schemes (MCSs). Generally speaking, MBSSID beacons are longer since they contain multiple profiles. There can be multiple MBSSID groups and correspondingly multiple MBSSID beacons sent by the same AP radio.

Client devices have generally learned not to transmit during these beacon +groupcast bursts (BBG transmissions) due to the high likelihood of collision. However, there is a substantial opportunity for enhanced NPCA operations based on DTIM groupcast duration information that is conventionally not “disclosed” outside of a given AP/radio. As noted above, an AP/radio knows exactly how many frames, their lengths, MCSs and inter-PPDU spacing that it is about to transmit. That is, the AP/radio knows the minimum duration of a given burst that it is about to transmit.

For example, with reference to FIG. 7, the BBG transmission 700 (and ICF 705, if utilized) can occur at a 20 MHz primary channel, labeled ‘P20’ in FIG. 7, which leaves a remaining spectrum (e.g., 60 MHz in the case of an 80 MHz bandwidth) available for NPCA operations, as shown at 708, labeled ‘Secondaries’.

One operating condition of NPCA operation under IEEE 802.11bn TGbn is that clients are to return to the primary channel following an NPCA transmission, typically referred to as a ‘switch-and-return’ operation. For DTIM groupcast burst transmissions, since the Duration field is 0 in each Beacon and each groupcast frame, this can appear as many short NPCA opportunities to OBSS client devices, which means that OBSS STAs seeking to use NPCA may need to perform NPCA switch-and-return operations 1-2-5-10-20-50-100 times during the Beacon and groupcast burst instead of a single switch-and-return or a reduced number of switch-and-returns, which can provide a substantial opportunity for AP devices and client devices to perform more power-efficient and air-time-efficient NPCA operations.

Embodiments herein provide for the ability of a first AP device, acting on behalf of one or more APs on the AP device's radio(s) to disclose or signal one or more NPCA opportunities to a second (OBSS) AP device and its client devices immediately before a Beacon+DTIM groupcast burst transmission (a BBG transmission) via ICF 705, early in a BBG transmission, and potentially one or more times within a BBG transmission. Embodiments/operations herein that provide for signaling NPCA opportunities by one AP device and performing operations to switch to an NPCA primary channel for communications by a neighboring AP device and its client devices can be referred to herein as enhanced or extended NPCA operations/embodiments. AP devices and client devices configured to operate in accordance with the enhanced/extended NPCA operations can be referred to herein as enhanced NPCA-enabled AP devices and enhanced NPCA-enabled client devices.

It is to noted that enhanced NPCA operations as discussed for embodiments herein can be used with only one AP/radio of a given enhanced NPCA-enabled AP device; yet, more value may be added when there are multiple beacons on an AP/radio (e.g., an enhanced NPCA-enabled AP device having an AP/radio with a co-hosted BSSID set or a MBSSID set) and/or a lot of groupcast to be transmitted.

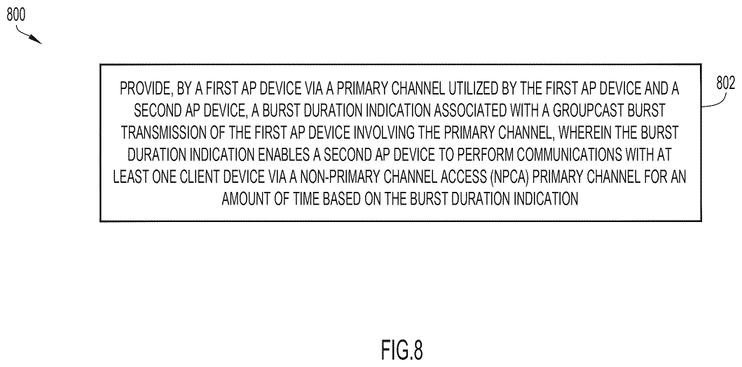

Referring to FIG. 8, FIG. 8 is a flowchart depicting a method 800 according to an example embodiment. In at least one embodiment, operations for method 800 may be performed by a first (enhanced NPCA-enabled) AP device, such as AP device 102 (APDev1) of FIG. 1A in order to signal at least one NPCA opportunity to a second (enhanced NPCA-enabled) AP device, such as AP device 132 (APDev2) of FIG. 1A.

As shown at 802, the method may include providing, by a first access point device via a primary channel utilized by the first AP device and a second AP device, a burst duration indication associated with a groupcast burst transmission of the first AP device involving the primary channel, wherein the duration burst indication enables the second device to perform communications with at least one client device via a Non-Primary Channel Access (NPCA) primary channel for an amount of time based on the burst duration indication

Various techniques are discussed herein, below, through which a burst duration indication associated with a groupcast burst transmission of a first AP device involving a primary channel that is also used by a second AP device can be provided or signaled to the second AP device and one or more client device communicating with the second AP device. The burst duration indication can enable the second AP device and the client devices connected thereto to perform communications via an NPCA primary channel for an amount of time based on the burst duration indication.

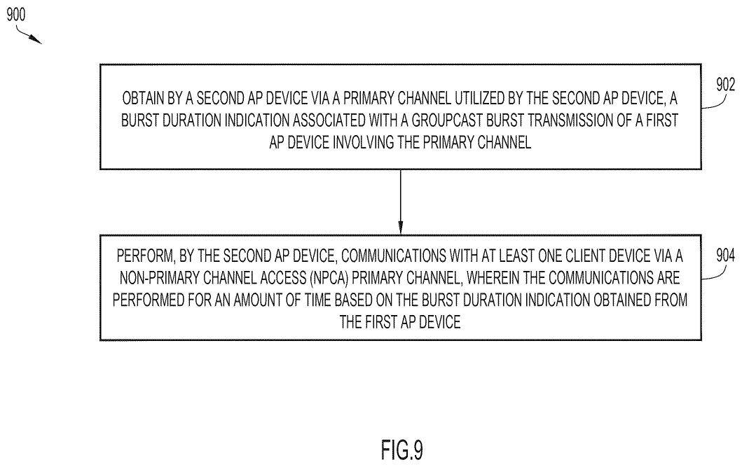

Referring to FIG. 9, FIG. 9 is a flowchart depicting a method 900 according to an example embodiment. In at least one embodiment, operations for method 900 may be performed by a second (enhanced NPCA-enabled) AP device (APDev2), such as AP device 132 of FIG. 1A, based on at least one NPCA opportunity signaled by a first (enhanced NPCA-enabled) AP device (APDev1), such as AP device 102 of FIG. 1A.

As shown at 902, the method may include obtaining by a second access point (AP) device via a primary channel utilized by the second AP device, a burst duration indication associated with a groupcast burst transmission of a first AP device involving the primary channel.

As shown at 904, the method may include performing, by the second AP device, communications with at least one client device via a Non-Primary Channel Access (NPCA) primary channel, wherein the communications are performed for an amount of time based on the burst duration indication obtained from the first AP device.

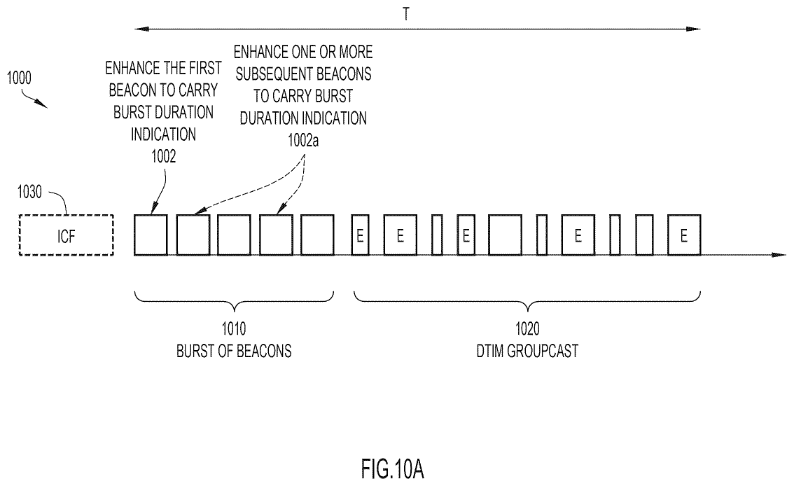

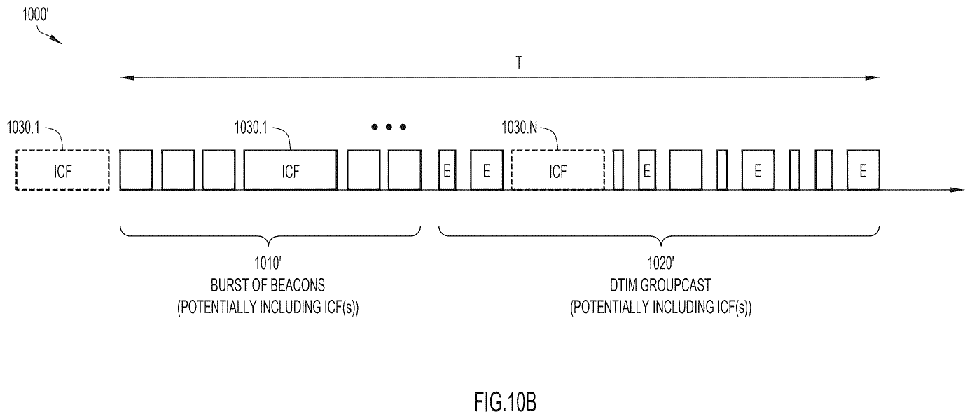

Referring to FIG. 10A, FIG. 10A is a diagram illustrating an example BBG transmission 1000 in which different mechanisms that can be used by a first (enhanced NPCA-enabled) AP device to signal at least one NPCA opportunity to a second (enhanced NPCA-enabled) AP device and one or more second clients devices connected to the second AP device via a primary channel. The primary channel that is utilized by the first AP device, first client devices connected to the first AP device, the second AP device, and the second client devices connected to the second AP device. BBG transmission 1000 includes a burst of beacons 1010 and a DTIM groupcast 1020 transmission.

Container Option A: a first AP device transmitting many xIFS-spaced beacons and/or many groupcast after the beacons (a BBG transmission) indicates such a BBG transmission (an NPCA opportunity) as early as possible to help an NPCA AP device and its associated client devices switch to the NPCA primary channel to perform communications during the BBG transmission of the first AP device.

One container option, with strong backwards compatibility, can include enhancing at least a first beacon frame of the BBG transmission 1000 (as generally shown at 1002) to include an indication of a BBG transmission (indicating an NPCA opportunity) and also including a burst duration indication for the NPCA opportunity. In a variation of this embodiment, in case the first beacon collided with other transmissions, one or more subsequent Beacons also may also carry a BBBG transmission indication and a burst duration indication for the BBG transmission, as generally shown at 1002a. In such embodiments, the one or more subsequent Beacons can carry a BBG transmission indication and a burst duration indication that identifies a duration of the BBG transmission that is remaining following the one or more preceding Beacons of the BBG transmission that have already been transmitted by the first AP device.

Container Option B: As a field including a burst duration indication in an Initial Control Frame (ICF)1030 sent at least before the first Beacon of a BBG transmission, and potentially at other times during the BBG transmission. This adds larger wireless overhead to the transmitting AP device. Therefore, the sending of this ICF (or multiple ICFs) should be enabled as part of a Multi-AP Coordination (MAPC) agreement with an OBSS AP device that has NPCA activated. For the embodiment of FIG. 10A, in which only a first ICF (1030) is sent before the first Beacon frame of the BBG transmission 1000, the burst duration indication can be set to a value based on the total duration (T) of the BBG transmission 1000.

Referring to FIG. 10B, FIG. 10B is a diagram illustrating an example BBG transmission 1000′ in which multiple ICFs can used by a first AP device to signal at least one NPCA opportunity such as a continuing sequence of NPCA opportunities to a second AP device and one or more (second) client devices connected to the second AP device via a primary channel that is utilized by the first AP device (and its client devices), the second AP device, and the (second) client device connected to the second AP device. BBG transmission 1000′ includes a burst of beacons 1010′ (that may include one or more ICFs) and a DTIM groupcast 1020′ transmission (that may include one or more ICFs).

The embodiment of FIG. 10B may be useful for scenarios in which a maximum value for a given burst duration indication may be agreed for use between AP devices (via a MAPC agreement negotiated/established between the AP devices) such that multiple ICFs may need to be transmitted by a given AP device to cover the entire duration (T) of a given BBG transmission.

For example, as shown in FIG. 10B a number of ICFs, such as an ICF 1030.1, an ICF 1030.2, through an IFC 1030.N may be signaled for the BBG transmission 1000′ in which ICF 1030.1 is signaled before a first beacon of the burst of beacons 1010′ and ICF 1030.2 through ICF 1030.N can be signaled anywhere during the BBG transmission, based on the total remaining duration of the transmission (T-remaining) and the maximum value of each burst duration indication that can be signaled in each ICF. In another variation, if the Beacon and/or groupcast frames are sent replicated in frequency and/or at wider than 20 MHz bandwidth, then the ICF can be sent in non-HT duplicate mode and can be replicated over the same bandwidth as the Beacon and/or groupcast frames. If the second AP device's NPCA primary channel still lies outside this wider bandwidth then the second AP device and its client devices might not share the same primary channel as the first AP device but can still identify elongated NPCA opportunities from a replicant of an ICF frame.

Where the beacons are transmitted as portions of a single SIFS-spaced Transmit Opportunity (TXOP), a control frame might instead be sent after the beacons and before the DTIM groupcast frames (e.g., about every 5 milliseconds).

Any ICF features as discussed above with reference to FIG. 6 can be used to carry a burst duration indication that can also facilitate the enhanced NPCA operations provided by embodiments herein.

Further, any PPDU and MAC/Beacon frame features as discussed above with reference to FIG. 5 can also be used to carry a burst duration indication that can also facilitate the enhanced NPCA operations provided by embodiments herein. For instance, in at least one embodiment a burst duration indication associated with a groupcast burst transmission can be included in a physical layer (PHY) header of at least one physical layer protocol data unit (PPDU) that carries a beacon frame or can be included in a frame body (e.g., as a new burst duration field) of at least one Beacon frame

In some embodiments, rather than use control frame(s), a first AP device may provide an indication of a BBG transmission (e.g., an ‘NPCA opportunity’) within a given Beacon frame in which the BBG transmission indication in combination with a burst duration indication included in the given Beacon frame can be used by a neighboring AP device (and its client devices) to both recognize a transmission from the first AP device as a BBG transmission (an NPCA opportunity) and switch to an NPCA primary channel to perform communications for a period of time based on the burst duration indication.

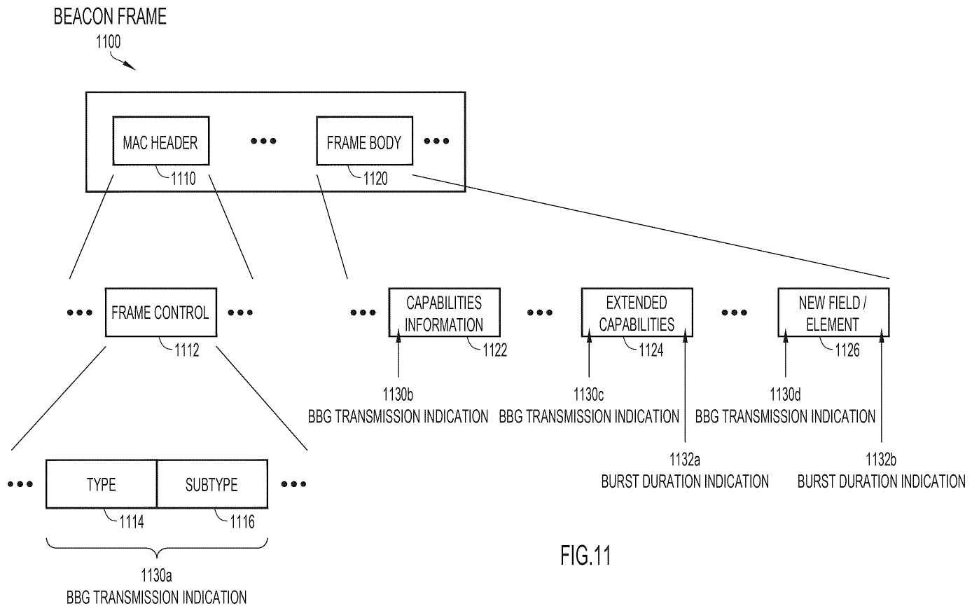

FIG. 11 is a schematic diagram illustrating example details for different fields of a Beacon frame 1100 that can be used to provide a BBG transmission indication (e.g., indicating an NPCA opportunity) by an AP device, according to an example embodiment. A PPDU including Beacon frame 1100 is not shown in FIG. 11 for purposes of brevity only.

The Beacon frame 1100 comprises various portions and fields, but of relevance to the embodiment of FIG. 11, the Beacon frame 1100 is shown to include a MAC header 1110 and a frame body 1120.

The MAC header 1110 contains various portions and fields, but of relevance to the embodiment of FIG. 11, the MAC header 1110 includes Frame Control field 1112, which may further include a Type field 1114 and a Subtype field 1116. In at least one embodiment, a number of bits of the Type field 1114 and/or the Subtype field 1116 can be enhanced to carry a BBG transmission indication 1130a (indicating an NPCA opportunity).

The frame body 1120 contains various portions and fields, but of relevance to the embodiment of FIG. 11, in at least one embodiment the frame body 1120 can include at least one of a Capabilities Information field 1122 and an Extended Capabilities element 1124.

Generally, the Capabilities Information field 1122 is a fixed field at order #3 within Beacon frames. In at least one embodiment, the Capabilities Information field 1122 can be enhanced to carry a BBG transmission indication 1130b, for example, indicating that a corresponding Beacon frame is part of a BBG transmission (e.g., 3× longer than the corresponding Beacon frame) thereby indicating an NPCA opportunity.

In at least one embodiment, the Extended Capabilities element 1124 can include a few bits enhanced to carry a BBG transmission indication 1130c, indicating that a corresponding Beacon frame is part of a BBG transmission (an NPCA opportunity). In at least one embodiment a burst duration indication 1132a can also be provided in the Extended Capabilities element 1124 after the BBG transmission indication 1130c.

In at least one embodiment, the frame body 1120 can be enhanced with a new field/element 1126 that can be configured to carry a BBG transmission indication 1130d, for example, indicating that a corresponding Beacon frame is part of a BBG transmission, thereby indicating an NPCA opportunity. In at least one embodiment a burst duration indication 1132b can also be provided in the new field/element 1126 after the BBG transmission indication 1130d.

This distribution of information enables backwards compatibility with legacy clients and early-as-possible abort with modern clients if the BBG duration is not carried/indicated for a given BBG transmission.

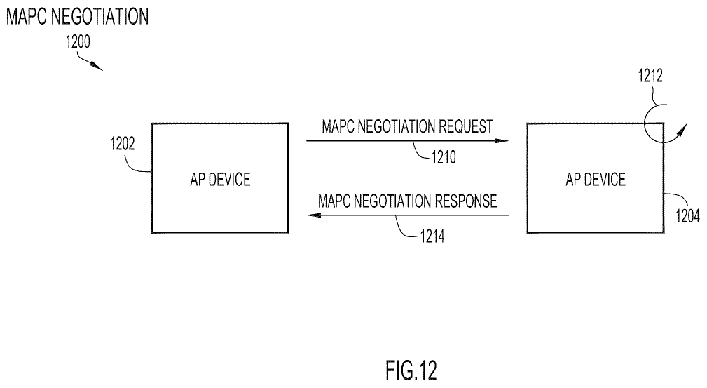

FIG. 12 is a block diagram 1200 illustrating example details for a Multi-Access Point Coordination (MAPC) discovery and/or negotiation that can be performed between enhanced NPCA-enabled AP devices, such as between an AP device 1202 and an AP device 1204 for enhanced NPCA operations, according to an example embodiment.

A MAPC agreement between two AP devices can include multiple MAPC sub-agreements. For example, one sub-agreement can be directed toward Time-Division Multiple Access (TDMA) operations, such as a Co-TDMA sub-agreement and another sub-agreement could be directed to the enhanced NPCA operations as discussed for embodiments herein. Thus, a MAPC agreement between two AP devices to facilitate/perform enhanced NPCA operations as discussed herein can be referred to as a MAPC sub-agreement to perform such enhanced NPCA operations.

Generally, a MAPC discovery or negotiation for either a MAPC agreement or a MAPC sub-agreement involves a first AP device sending a Discovery or Negotiation Request frame to a second AP device with the second AP device sending a corresponding Discovery/Negotiation Response frame to the first AP device. For example, with reference to FIG. 12, consider that a MAPC negotiation is performed between AP device 1202 and AP device 1204 for a MAPC sub-agreement between the AP devices related to enhanced NPCA operations as discussed for embodiments herein. As shown at 1210, consider that AP device 1202 initiates the MAPC negotiation by sending MAPC Negotiation Request frame to AP device 1204. As generally shown at 1212, AP device 1204 can determine/generate a MAPC Negotiation Response frame based on the AP device 1202 Negotiation Request frame and can send the MAPC Negotiation Response frame to AP device 1202, as shown at 1214.

In at least one embodiment, the MAPC Request frame can be provided by AP device 1202 with a field indicating:
“Request you to send an ICF frame indicating a long beacon+DTIM groupcast burst duration immediately before the groupcast burst [with possible responses: can/won't reciprocate]”

Such a request may be worthwhile for scenarios in which there might be a minimum duration that a given AP device might consider to be a “long” transmission by neighboring AP device (e.g., send ICF if frames after first beacon last at least 0.5/1/2/4/8 msec).

In at least one embodiment, a possible MAPC Response frame may include a reason code indicating one of: ‘Accept’, ‘Accept subject to reciprocation’, ‘Reject’, or variations thereof.

In some instances, an IEEE Standard or an amendment thereof might define the threshold above which a given transmission qualifies as a long burst or the industry might converge on reasonable behavior. Alternatively, a threshold for a “long” burst might be negotiated, such as:
A Negotiation Request might include one threshold along with some defined or signaled semantics such as “Must be satisfied”/“Proposed”; or propose a range of thresholds (e.g., “1 TU or higher” or “1-20 TU”) with semantics such as “Responder to pick one in this range”;
A Negotiation Response might include the responder's preferred value if the previous reason codes are some kind of ‘Accept’/etc., otherwise, the responder could respond with “Reject for now but would accept a request for this value/range of values”.
Other variations can be envisioned.

In at least one embodiment, ta threshold might be sent as a linear value with e.g., 32 μsec units, taken from a table, using a piecewise linear or power of two encoding, etc.

Accordingly, in at least one embodiment, a MAPC sub-agreement can be established between a first AP device and a second AP device that defines that the first AP device is to provide a burst duration indication for any groupcast burst transmission of the first AP device. In another embodiment a MAPC sub-agreement can be established between a first AP device and a second AP device that defines that the first AP device is to provide a burst duration indication for any groupcast burst transmission of the first AP device that is to exceed a threshold amount of time.

Thus, there are opportunities for NPCA operations during bursts of Beacons and DTIM groupcast transmissions, as well as power saving opportunities by OBSS client devices in accordance with embodiments herein. In current deployments, these NPCA opportunities are presently hard to harvest given the disjoint Duration fields. The disjoint Duration fields during the groupcast is a feature; this enables OBSS AP devices to transmit their beacons in the middle of groupcast bursts. It is therefore desirable to have additional early signaling to indicate the burst duration as discussed for embodiments herein. One “least-worst” option may include sending an ICF before a longer Beacon and DTIM groupcast burst (BBG transmission) as discussed for embodiments herein. This may be enabled after MAPC negotiation in at least one embodiment. For instance, in at least one embodiment, a MAPC Discovery Request or Response frame might report a policy such as an indication “Desire for/MAPC agreement is conditional on the peer sending an ICF frame indicating a long beacon+DTIM groupcast burst duration immediately beforehand [, with reciprocity].”

Accordingly, embodiments are presented herein to assist MLO client device save power during DTIM groupcast bursts on links where a client device is not obtaining groupcast. Embodiments are also presented herein to assist NPCA primary channel communications between a particular AP device and its client devices for periods in which a neighboring AP device is performing BBG transmissions via a primary channel that is also used by the particular AP device (and its client devices). For example, at least one embodiment may involve a given AP device/its client devices determining whether the burst of beacons groupcast (BBG) feature is enabled for a neighboring AP device in which the given AP device/its clients can jump the NPCA primary channel for communications until the earlier of a next Target Beacon Transmission Time (TBTT) or the end of the BBG burst indicated for a current BBG transmission.

Embodiments are also presented herein to address different scenarios that involve policing of control frames or authorizing of control frames for enhanced NPCA scenarios involving neighboring AP devices.

As noted above, client devices have generally learned to not transmit during Beacon +groupcast bursts due to the high likelihood of collision.

One potential problem of sending a control frame before the burst of beacons and groupcast (BBG) for NPCA operations is the potential situation in which an attacker, such an OBSS AP device, transmits a BBG control frame (ICF) or other BBG transmission indication (e.g., in a Beacon frame), but does not actually perform a BBG transmission thereafter. For example, consider a scenario involving enhanced NPCA-enabled AP devices (APDev), enhanced NPCA-enabled client devices (EnhancedClients), and client devices that are not enhanced NPCA-enabled devices, referred to herein as ‘legacy’ client devices (LegacyClients). For the example scenario, a first enhanced NPCA-enabled AP device (APDev1) can serve both enhanced NPCA-enabled client device (EnhancedClients1) and legacy client device (LegacyClients1). In this scenario, a second enhanced NPCA-Enabled AP device (APDev2) can serve its own clients (clients2). Consider that APDev1 and APDev2 share the same primary channel and that APDev2 may be considered an ‘attacker’ in this example. The following events may occur in sequence:
APDev2 sends a BBG control frame (ICF);
APDev1 and EnhancedClients1 jump to the NPCA primary channel (i.e., a different primary channel);
Scenario1: Legacy DoS (Denial of Service):
   APDev2 does not send anything (i.e., does not send a BBG transmission after the ICF). APDev2 may not have any clients; but regardless no/little clients2 traffic is expected.
   LegacyClients1 see a free channel and may try to transmit to their APDev1, perhaps just on the primary channel, but APDev1 is not listening on the primary channel now. Rather, APDev1 is listening on the NPCA primary channel, so LegacyClients1 try and retry etc., and may drop frames that have been tried too many times and/or (in certain narrow corner cases) might even give up on APDev1 and roam away to another AP device. Basically, this is disruptive to LegacyClients1-a denial of service (DoS) attack.
Scenario2: Reduced congestion access for APDev2 and clients2:
   APDev2 has just sent APDev1 and EnhancedClients1 (and any other enhanced NPCA-enabled AP/client devices) away from the primary channel, so APDev2 sees less congestion with fewer co-channel contending client devices. Therefore, it can achieve fewer collisions with earlier channel access and thus achieve higher throughput and lower latency.

Given such potential issues, mitigations are desired. Various policing embodiments and authorization embodiments are provided herein to mitigate such potential issues.

### Policing Embodiments

In at least one embodiment, MAPC sub-agreements between AP devices in different administrative domains and/or from different vendors regarding enhanced NPCA operations can benefit from policing, to ensure that a partnered AP device is not cheating or operating outside a given MAPC sub-agreement (such as in the two scenarios above).

In at least one embodiment, an AP device, such as AP device 102 and AP device 132 may have an extra “scan” or “auxiliary” radio that can be used to monitor different channels than those used by the serving radio. For some fraction of the time in such an embodiment, a given AP device's scan radio can be used monitor the primary channel and look for any instances of a neighboring AP device sending a BBG control frame (ICF) or other BBG transmission indication (e.g., in a beacon frame) and then not actually sending a burst of beacons +groupcast transmission, or performing such a BBG transmission for a shorter time than indicated.

In at least one embodiment, an AP device may intermittently not jump to the NPCA primary channel and instead listen on the primary channel. Alternatively, an AP device may jump back to the primary channel partway through the signaled BBG duration.

If a violation happens (or happens too often), a particular AP device can mitigate the problem through one or more of the following:
Teardown or otherwise limit the MAPC sub-agreement with the (violating) AP device;
Notify its enhanced NPCA-enabled client device to ignore such BBG control frames or other BBG transmission indications (e.g., included in Beacon frame(s)) sent by the (violating) AP device. However, this would involve enhanced NPCA-enabled client devices to maintain allowlists and/or denylists of AP devices whose BBG control frames/BBG transmission indications are trusted, which can be onerous and also not scalable;
Notify its enhanced NPCA-enabled client device to ignore all BBG control frames/BBG transmission indications, in other words, cancel use of the BBG control frame/BBG transmission indication feature. This may be more implementable but undermines the benefits related to trustworthy AP devices. However, a “bad” AP device is probably violating regulatory rules and/or the Wi-Fi Alliance's (WFA's) Extensions Policy, so this type of DoS attack may be less likely in practice.

### Authorizing Embodiments

Aside from policing embodiments as discussed above, various authorizing embodiments may be performed by an AP device for enhanced NPCA-enabled operations.

In at least embodiment, before a given AP device starts its burst of beacons and groupcast transmission, the AP device can send BBG control frame/BBG transmission indication, but now the control frame/beacon frame may also poll each OBSS AP device with which the given AP device has a (NPCA) MAPC sub-agreement. In this embodiment, the given AP device may wait for a recipient AP device to transmit a response frame (which may be a protected frame) via the primary channel indicating if recipient trusts the BBG control frame/beacon frame sender or not. In at least one embodiment client devices of the (recipient) AP device may wait for this “all clear” signaling from the (recipient) AP device via the primary channel and verify its protection if a protected frame is expected, before jumping to the NPCA primary channel.

Another challenge may occur when an enhanced NPCA-enabled AP device (APDev1) serves enhanced NPCA-enabled clients that may or may not be in a power saving (PS) mode. For example, a neighboring enhanced NPCA-enabled AP device (APDev2) (just nearby, not an attacker in this example scenario) might serve its own client devices in which both APDev1 and APDev2 share the same primary channel. In this example, the following events occur in sequence:
APDev2 reports a BBG control frame/BBG transmission indication for a burst with lots of groupcast;
APDev1 and its client devices jump to the NPCA primary channel (i.e., a different primary channel);
APDev1's Target Beacon Transmission Time (TBTT) occurs during APDev2's groupcast transmission. In the normal course of events, APDev1 would transmit its beacons at PIFS in the middle of the groupcast transmission and win the channel. Its PS clients would (typically) not see buffered traffic for them and could immediately go to sleep. That is, for APDev1 (and its clients) to stay past their TBTT on the NPCA primary channel is not desirable.

For this situation, a more nuanced rule may be used for a BBG control frame/BBG transmission indication at APDev1 and its enhanced NPCA-enabled client devices, as follows:
Upon receipt of a BBG control frame/BBG transmission indication on the primary channel, <if the BBG feature is enabled and not disabled as per the techniques described above>, then jump to the NPCA primary channel;
Continue NPCA operation on the NPCA primary channel until the earlier of the next TBTT or the end of the BBG burst indicated;
Then revert to the primary channel as usual.

That is, an enhanced NPCA-enabled AP device and its clients may perform an early end to NPCA operations based on TBTT of the enhanced NPCA-enabled AP device.

Accordingly, in at least one embodiment, a method can include establishing a multi-AP coordination (MAPC) sub-agreement between a second AP device and a first AP device that defines that the first AP device is to provide the duration indication for any groupcast burst transmission of the first AP device or for any groupcast burst transmission that is to exceed a threshold amount of time. In one instance, the method can include during the amount of time based on the burst duration indication, determining by the second AP device whether the first AP device is performing the groupcast burst transmission involving the primary channel. In one instance, the method can further include, upon the second AP device determining that the first AP device is not performing the groupcast burst transmission involving the primary channel, the second AP device performing, at least one of: tearing down of the MAPC sub-agreement; or establishing a new MAPC sub-agreement between the second AP device and the first AP device.

In one instance, the method may further include, upon the second AP device determining that the first AP device is not performing the groupcast burst transmission involving the primary channel, the second AP device performing, at least one of: notifying the at least one client device to ignore any burst duration indication associated with a groupcast burst transmission of a first AP involving the primary channel obtained from the first AP device; or notifying the at least one client device to ignore any burst duration indication associated with any groupcast burst transmission of any AP involving the primary channel.

In at least one embodiment, the method may further include, prior to performing, by the second AP, the communications with at least one client device via the NPCA primary channel, providing, by the second AP device, an authorizing indication receivable by the at least one client device via the primary channel indicating that the second AP device is to perform the communications via the NPCA primary channel, wherein the authorizing indication enables the at least one client device to perform the communications with the second AP device via the NPCA primary channel.

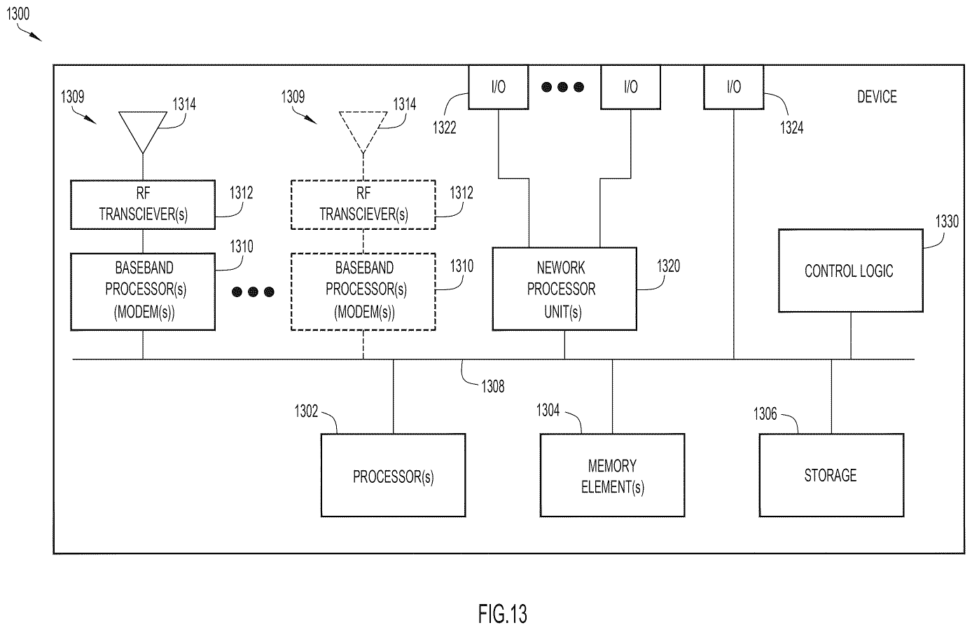

Referring to FIG. 13, FIG. 13 illustrates a hardware block diagram of an apparatus or device 1300 that may perform functions associated with operations discussed herein in connection with the techniques described for embodiments herein. Device 1300 may be inclusive of any AP device and any client device as discussed for embodiments herein.

In at least one embodiment, the device 1300 may be any apparatus that may include one or more processor(s) 1302, one or more memory element(s) 1304, storage 1306, a bus 1308, one or more radio modules 1309 each consisting of a baseband processor (modem) 1310, one or more RF transceivers 1312 and an antenna 1314 (or group of antennas). The device 1300 may further include one or more network processor unit(s) 1320 interconnected with one or more network input/output (I/O) interface(s) 1322, one or more I/O interface(s) 1324, and control logic 1330. In various embodiments, instructions associated with logic for device 1300 can overlap in any manner and are not limited to the specific allocation of instructions and/or operations described herein.

In at least one embodiment, processor(s) 1302 is/are at least one hardware processor configured to execute various tasks, operations and/or functions for device 1300 as described herein according to software and/or instructions configured for device 1300. Processor(s) 1302 (e.g., a hardware processor) can execute any type of instructions associated with data to achieve the operations detailed herein. In one example, processor(s) 1302 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1304 and/or storage 1306 is/are configured to store data, information, software, and/or instructions associated with device 1300, and/or logic configured for memory element(s) 1304 and/or storage 1306. For example, any logic described herein (e.g., control logic 1330) can, in various embodiments, be stored for device 1300 using any combination of memory element(s) 1304 and/or storage 1306. Note that in some embodiments, storage 1306 can be consolidated with memory element(s) 1304 (or vice versa) or can overlap/exist in any other suitable manner.

In at least one embodiment, bus 1308 can be configured as an interface that enables one or more elements of device 1300 to communicate in order to exchange information and/or data. Bus 1308 can be implemented with any architecture designed for passing control, data and/or information between processors, memory elements/storage, peripheral devices, and/or any other hardware and/or software components that may be configured for device 1300. In at least one embodiment, bus 1308 may be implemented as a fast kernel-hosted interconnect, potentially using shared memory between processes (e.g., logic), which can enable efficient communication paths between the processes.

In various embodiments, network processor unit(s) 1320 may enable communication between device 1300 and other systems, entities, etc., via network I/O interface(s) 1322 (wired and/or wireless) to facilitate operations discussed for various embodiments described herein. In various embodiments, network processor unit(s) 1320 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 1300 and other systems, entities, etc. to facilitate operations for various embodiments described herein. In various embodiments, network I/O interface(s) 1322 can be configured as one or more Ethernet port(s), Fibre Channel ports, any other I/O port(s), and/or antenna(s)/antenna array(s) now known or hereafter developed. Thus, the network processor unit(s) 1320 and/or network I/O interface(s) 1322 may include suitable interfaces for receiving, transmitting, and/or otherwise communicating data and/or information (wired and/or wirelessly) in a network environment.

I/O interface(s) 1324 allow for input and output of data and/or information with other entities that may be connected to device 1300. For example, I/O interface(s) 1324 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 1312 may perform RF transmission and RF reception of wireless signals via antenna(s) 1314, and the baseband processor or modem 1310 performs baseband modulation and demodulation, etc. associated with such signals to enable wireless communications for device 1300.

In various embodiments, control logic 1330 can include instructions that, when executed, cause processor(s) 1302 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1304 and/or storage 1306 can store data, software, code, instructions (e.g., processor instructions), logic, parameters, combinations thereof, and/or the like used for operations described herein. This includes memory element(s) 1304 and/or storage 1306 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as described herein. In one form, an apparatus as described herein is provided. In one form, a system as described herein is provided. In one form, one or more non-transitory computer readable storage media encoded with software comprising computer executable instructions is/are provided herein that, when executed, is/are operable to perform operations described herein.

In some aspects, the techniques described herein relate to a method including: receiving via each corresponding wireless link of a plurality of wireless links of a client device, a corresponding burst duration indication for a corresponding groupcast burst transmission that is to be provided by each corresponding wireless link of a plurality of wireless links of an access point (AP) device, wherein the plurality of wireless links of the client device include a groupcast link and at least one non-groupcast link; and causing operation of the client device on the at least one non-groupcast link to enter a sleep state for an amount of time based on the corresponding burst duration indication obtained for the at least one non-groupcast link.

In some aspects, the techniques described herein relate to a method, wherein each corresponding wireless link of the plurality of wireless links of the client device is provided by each of a plurality of radios of the client device that are affiliated to provide a multi-link device for the client device.

In some aspects, the techniques described herein relate to a method, wherein causing operation of the client device on the at least one non-groupcast link to enter the sleep state for the amount of time based on the corresponding burst duration indication includes causing at least one radio of the plurality of radios to enter the sleep state in which the at least one radio facilitates the at least one non-groupcast link.

In some aspects, the techniques described herein relate to a method, wherein the corresponding groupcast burst transmission is a Delivery Traffic Indication Message (DTIM) groupcast burst transmission including one or more beacon frames and zero or more groupcast frames.

In some aspects, the techniques described herein relate to a method, wherein the corresponding burst duration indication corresponds to one of: a remaining duration of the one or more beacon frames and the zero or more groupcast frames; or a remaining duration of a particular groupcast frame.

In some aspects, the techniques described herein relate to a method, wherein the corresponding burst duration indication is included in one of: a physical layer (PHY) header of at least one physical layer protocol data unit of the corresponding groupcast burst transmission; a media access control (MAC) header of at least one groupcast frame of the corresponding groupcast burst transmission; or a frame body of at least one beacon frame.

In some aspects, the techniques described herein relate to a method, wherein the corresponding burst duration indication is included in a control frame that precedes a first beacon frame of the corresponding groupcast burst transmission.

In some aspects, the techniques described herein relate to one or more non-transitory computer readable storage media encoded with instructions that, when executed by a processor, cause the processor to perform operations, comprising: receiving via each corresponding wireless link of a plurality of wireless links of a client device, a corresponding burst duration indication for a corresponding groupcast burst transmission that is to be provided by each corresponding wireless link of a plurality of wireless links of an access point (AP) device, wherein the plurality of wireless links of the client device include a groupcast link and at least one non-groupcast link; and causing operation of the client device on the at least one non-groupcast link to enter a sleep state for an amount of time based on the corresponding burst duration indication obtained for the at least one non-groupcast link.

In some aspects, the techniques described herein relate to an apparatus comprising: at least one memory element for storing data; and at least one processor for executing instructions associated with the data, wherein executing the instructions causes the apparatus to perform operations, comprising: receiving via each corresponding wireless link of a plurality of wireless links of a client device, a corresponding burst duration indication for a corresponding groupcast burst transmission that is to be provided by each corresponding wireless link of a plurality of wireless links of an access point (AP) device, wherein the plurality of wireless links of the client device include a groupcast link and at least one non-groupcast link; and causing operation of the client device on the at least one non-groupcast link to enter a sleep state for an amount of time based on the corresponding burst duration indication obtained for the at least one non-groupcast link.

In some aspects, the techniques described herein relate to a system comprising: at least one memory element for storing data; and at least one processor for executing instructions associated with the data, wherein executing the instructions causes the system to perform operations, comprising: receiving via each corresponding wireless link of a plurality of wireless links of a client device, a corresponding burst duration indication for a corresponding groupcast burst transmission that is to be provided by each corresponding wireless link of a plurality of wireless links of an access point (AP) device, wherein the plurality of wireless links of the client device include a groupcast link and at least one non-groupcast link; and causing operation of the client device on the at least one non-groupcast link to enter a sleep state for an amount of time based on the corresponding burst duration indication obtained for the at least one non-groupcast link.

In some aspects, the techniques described herein relate to a method including: transmitting, by an access point (AP) device to a client device, a corresponding burst duration indication for a corresponding groupcast burst transmission for each corresponding wireless link of a plurality of wireless links provided by the AP device, wherein the client device is to cause operation of the client device on at least one wireless link of a plurality of wireless links of the client device to enter a sleep state for an amount of time based on the corresponding burst duration indication obtained for the at least one wireless link.

In some aspects, the techniques described herein relate to a method, wherein each corresponding wireless link of the plurality of wireless links of the AP device is provided by each of a plurality of radios of the AP device that are affiliated to provide a multi-link device for the AP device.

In some aspects, the techniques described herein relate to a method, wherein each wireless link of the plurality of wireless links of the client device is provided by each of a plurality of radios of the client device that are affiliated to provide a multi-link device for the client device.

In some aspects, the techniques described herein relate to a method, wherein the corresponding burst duration indication is included in one of: a physical layer (PHY) header of at least one physical layer protocol data unit of the corresponding groupcast burst transmission; a media access control (MAC) header of at least one groupcast frame of the corresponding groupcast burst transmission; or a frame body of at least one beacon frame.

In some aspects, the techniques described herein relate to a method, wherein the corresponding burst duration indication is included in a control frame that precedes a first beacon frame of the corresponding groupcast burst transmission.

In some aspects, the techniques described herein relate to a method, wherein the corresponding burst duration indication corresponds to one of: a remaining duration of one or more beacon frames and zero or more groupcast frames of the corresponding groupcast burst transmission; or a remaining duration of a particular groupcast frame of the corresponding groupcast burst transmission.

In some aspects, the techniques described herein relate to one or more non-transitory computer readable storage media encoded with instructions that, when executed by a processor, cause the processor to perform operations, comprising: transmitting, by an access point (AP) device to a client device, a corresponding burst duration indication for a corresponding groupcast burst transmission for each corresponding wireless link of a plurality of wireless links provided by the AP device, wherein the client device is to cause operation of the client device on at least one wireless link of a plurality of wireless links of the client device to enter a sleep state for an amount of time based on the corresponding burst duration indication obtained for the at least one wireless link.

In some aspects, the techniques described herein relate to a system comprising: at least one memory element for storing data; and at least one processor for executing instructions associated with the data, wherein executing the instructions causes the system to perform operations, comprising: transmitting, by an access point (AP) device to a client device, a corresponding burst duration indication for a corresponding groupcast burst transmission for each corresponding wireless link of a plurality of wireless links provided by the AP device, wherein the client device is to cause operation of the client device on at least one wireless link of a plurality of wireless links of the client device to enter a sleep state for an amount of time based on the corresponding burst duration indication obtained for the at least one wireless link.

In some aspects, the techniques described herein relate to an apparatus comprising: at least one memory element for storing data; and at least one processor for executing instructions associated with the data, wherein executing the instructions causes the apparatus to perform operations, comprising: transmitting, by an access point (AP) device to a client device, a corresponding burst duration indication for a corresponding groupcast burst transmission for each corresponding wireless link of a plurality of wireless links provided by the AP device, wherein the client device is to cause operation of the client device on at least one wireless link of a plurality of wireless links of the client device to enter a sleep state for an amount of time based on the corresponding burst duration indication obtained for the at least one wireless link.

In some aspects, the techniques described herein relate to a method including: providing, by a first access point (AP) device via a primary channel utilized by the first AP device and a second AP device, a burst duration indication associated with a groupcast burst transmission of the first AP device involving the primary channel, wherein the burst duration indication enables a second AP device to perform communications with at least one client device via a Non-Primary Channel Access (NPCA) primary channel for an amount of time based on the burst duration indication.

In some aspects, the techniques described herein relate to a method, wherein the burst duration indication is included in one of: a physical layer (PHY) header of at least one physical layer protocol data unit of the groupcast burst transmission; or a frame body of at least one beacon frame of the groupcast burst transmission.

In some aspects, the techniques described herein relate to a method, wherein the burst duration indication is included in a control frame that precedes a first beacon frame of the groupcast burst transmission.

In some aspects, the techniques described herein relate to a method, wherein the burst duration indication is included in a control frame that is after a first beacon frame of the groupcast burst transmission.

In some aspects, the techniques described herein relate to a method, further including: providing an indicator of the groupcast burst transmission within at least one control frame or within at least one beacon frame.

In some aspects, the techniques described herein relate to a method, wherein the indicator of the groupcast burst transmission is included in a frame control field of a Media Access Control (MAC) header of the at least one beacon frame of the groupcast burst transmission.

In some aspects, the techniques described herein relate to a method, wherein the indicator of the groupcast burst transmission is included in a capabilities information field of at least one beacon frame of the groupcast burst transmission.

In some aspects, the techniques described herein relate to a method, wherein the indicator of the groupcast burst transmission is included in an extended capabilities element of at least one beacon frame of the groupcast burst transmission.

In some aspects, the techniques described herein relate to a method, further including: establishing a multi-AP coordination (MAPC) sub-agreement between the first AP device and the second AP device defines that the first AP device is to provide the burst duration indication for any groupcast burst transmission of the first AP device.

In some aspects, the techniques described herein relate to a method, further including: establishing a multi-AP coordination (MAPC) sub-agreement between the first AP device and the second AP device that defines that the first AP device is to provide the burst duration indication for any groupcast burst transmission of the first AP device that is to exceed a threshold amount of time.

In some aspects, the techniques described herein relate to one or more non-transitory computer readable storage media encoded with instructions that, when executed by a processor, cause the processor to perform operations, comprising: providing, by a first access point (AP) device via a primary channel utilized by the first AP device and a second AP device, a burst duration indication associated with a groupcast burst transmission of the first AP device involving the primary channel, wherein the burst duration indication enables a second AP device to perform communications with at least one client device via a Non-Primary Channel Access (NPCA) primary channel for an amount of time based on the burst duration indication.

In some aspects, the techniques described herein relate to a system comprising: at least one memory element for storing data; and at least one processor for executing instructions associated with the data, wherein executing the instructions causes the system to perform operations, comprising: providing, by a first access point (AP) device via a primary channel utilized by the first AP device and a second AP device, a burst duration indication associated with a groupcast burst transmission of the first AP device involving the primary channel, wherein the burst duration indication enables a second AP device to perform communications with at least one client device via a Non-Primary Channel Access (NPCA) primary channel for an amount of time based on the burst duration indication.

In some aspects, the techniques described herein relate to an apparatus comprising: at least one memory element for storing data; and at least one processor for executing instructions associated with the data, wherein executing the instructions causes the apparatus to perform operations, comprising: providing, by a first access point (AP) device via a primary channel utilized by the first AP device and a second AP device, a burst duration indication associated with a groupcast burst transmission of the first AP device involving the primary channel, wherein the burst duration indication enables a second AP device to perform communications with at least one client device via a Non-Primary Channel Access (NPCA) primary channel for an amount of time based on the burst duration indication.

In some aspects, the techniques described herein relate to a method including: obtaining by a second access point (AP) device via a primary channel utilized by the second AP device, a burst duration indication associated with a groupcast burst transmission of a first AP device involving the primary channel; and performing, by the second AP device, communications with at least one client device via a Non-Primary Channel Access (NPCA) primary channel, wherein the communications are performed for an amount of time based on the burst duration indication obtained from the first AP device.

In some aspects, the techniques described herein relate to a method, further including: establishing a multi-AP coordination (MAPC) sub-agreement between the second AP device and the first AP device that defines that the first AP device is to provide the burst duration indication for any groupcast burst transmission of the first AP device or for any groupcast burst transmission that is to exceed a threshold amount of time.

In some aspects, the techniques described herein relate to a method, further including: during the amount of time based on the burst duration indication, determining by the second AP device whether the first AP device is performing the groupcast burst transmission involving the primary channel.

In some aspects, the techniques described herein relate to a method, further including: upon the second AP device determining that the first AP device is not performing the groupcast burst transmission involving the primary channel, the second AP device performing, at least one of: tearing down of the MAPC sub-agreement; or establishing a new MAPC sub-agreement between the second AP device and the first AP device.

In some aspects, the techniques described herein relate to a method, further including: upon the second AP device determining that the first AP device is not performing the groupcast burst transmission involving the primary channel, the second AP device performing, at least one of: notifying the at least one client device to ignore any burst duration indication associated with a groupcast burst transmission of a first AP involving the primary channel obtained from the first AP device; or notifying the at least one client device to ignore any burst duration indication associated with any groupcast burst transmission of any AP involving the primary channel.

In some aspects, the techniques described herein relate to a method, further including: prior to performing, by the second AP device, the communications with at least one client device via the NPCA primary channel, providing, by the second AP device, an authorizing indication receivable by the at least one client device via the primary channel indicating that the second AP device is to perform the communications via the NPCA primary channel, wherein the authorizing indication enables the at least one client device to perform the communications with the second AP device via the NPCA primary channel.

In some aspects, the techniques described herein relate to a method, wherein the burst duration indication is included in one of: a physical layer (PHY) header of at least one physical layer protocol data unit of the groupcast burst transmission; or a frame body of at least one beacon frame of the groupcast burst transmission.

In some aspects, the techniques described herein relate to a method, wherein the burst duration indication is included in a control frame that precedes a first beacon frame of the groupcast burst transmission.

In some aspects, the techniques described herein relate to a method, wherein the burst duration indication is included in a control frame that is after a first beacon frame of the groupcast burst transmission.

In some aspects, the techniques described herein relate to one or more non-transitory computer readable storage media encoded with instructions that, when executed by a processor, cause the processor to perform operations, comprising: obtaining by a second access point (AP) device via a primary channel utilized by the second AP device, a burst duration indication associated with a groupcast burst transmission of a first AP device involving the primary channel; and performing, by the second AP device, communications with at least one client device via a Non-Primary Channel Access (NPCA) primary channel, wherein the communications are performed for an amount of time based on the burst duration indication obtained from the first AP device.

In some aspects, the techniques described herein relate to a system comprising: at least one memory element for storing data; and at least one processor for executing instructions associated with the data, wherein executing the instructions causes the system to perform operations, comprising: obtaining by a second access point (AP) device via a primary channel utilized by the second AP device, a burst duration indication associated with a groupcast burst transmission of a first AP device involving the primary channel; and performing, by the second AP device, communications with at least one client device via a Non-Primary Channel Access (NPCA) primary channel, wherein the communications are performed for an amount of time based on the burst duration indication obtained from the first AP device.

In some aspects, the techniques described herein relate to an apparatus comprising: at least one memory element for storing data; and at least one processor for executing instructions associated with the data, wherein executing the instructions causes the apparatus to perform operations, comprising: obtaining by a second access point (AP) device via a primary channel utilized by the second AP device, a burst duration indication associated with a groupcast burst transmission of a first AP device involving the primary channel; and performing, by the second AP device, communications with at least one client device via a Non-Primary Channel Access (NPCA) primary channel, wherein the communications are performed for an amount of time based on the burst duration indication obtained from the first AP device.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 7®)/Wi-Fi8®/etc., IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving via each corresponding wireless link of a plurality of wireless links of a client device, a corresponding burst duration indication for a corresponding groupcast burst transmission that is to be provided by each corresponding wireless link of a plurality of wireless links of an access point (AP) device, wherein the plurality of wireless links of the client device include a groupcast link and at least one non-groupcast link; and
causing operation of the client device on the at least one non-groupcast link to enter a sleep state for an amount of time based on the corresponding burst duration indication obtained for the at least one non-groupcast link.

2. The method of claim 1, wherein each corresponding wireless link of the plurality of wireless links of the client device is provided by each of a plurality of radios of the client device that are affiliated to provide a multi-link device for the client device.

3. The method of claim 2, wherein causing operation of the client device on the at least one non-groupcast link to enter the sleep state for the amount of time based on the corresponding burst duration indication includes causing at least one radio of the plurality of radios to enter the sleep state in which the at least one radio facilitates the at least one non-groupcast link.

4. The method of claim 1, wherein the corresponding groupcast burst transmission is a Delivery Traffic Indication Message (DTIM) groupcast burst transmission comprising one or more beacon frames and zero or more groupcast frames.

5. The method of claim 4, wherein the corresponding burst duration indication corresponds to one of:
a remaining duration of the one or more beacon frames and the zero or more groupcast frames; or
a remaining duration of a particular groupcast frame.

6. The method of claim 1, wherein the corresponding burst duration indication is included in one of:
a physical layer (PHY) header of at least one physical layer protocol data unit of the corresponding groupcast burst transmission;
a media access control (MAC) header of at least one groupcast frame of the corresponding groupcast burst transmission; or
a frame body of at least one beacon frame.

7. The method of claim 1, wherein the corresponding burst duration indication is included in a control frame that precedes a first beacon frame of the corresponding groupcast burst transmission.

8. A method comprising:
transmitting, by an access point (AP) device to a client device, a corresponding burst duration indication for a corresponding groupcast burst transmission for each corresponding wireless link of a plurality of wireless links provided by the AP device, wherein the client device is to cause operation of the client device on at least one wireless link of a plurality of wireless links of the client device to enter a sleep state for an amount of time based on the corresponding burst duration indication obtained for the at least one wireless link.

9. The method of claim 8, wherein each corresponding wireless link of the plurality of wireless links of the AP device is provided by each of a plurality of radios of the AP device that are affiliated to provide a multi-link device for the AP device.

10. The method of claim 8, wherein each wireless link of the plurality of wireless links of the client device is provided by each of a plurality of radios of the client device that are affiliated to provide a multi-link device for the client device.

11. The method of claim 8, wherein the corresponding burst duration indication is included in one of:
a physical layer (PHY) header of at least one physical layer protocol data unit of the corresponding groupcast burst transmission;
a media access control (MAC) header of at least one groupcast frame of the corresponding groupcast burst transmission; or
a frame body of at least one beacon frame.

12. The method of claim 8, wherein the corresponding burst duration indication is included in a control frame that precedes a first beacon frame of the corresponding groupcast burst transmission.

13. The method of claim 8, wherein the corresponding burst duration indication corresponds to one of:
a remaining duration of one or more beacon frames and zero or more groupcast frames of the corresponding groupcast burst transmission; or
a remaining duration of a particular groupcast frame of the corresponding groupcast burst transmission.

14. A method comprising:
providing, by a first access point (AP) device via a primary channel utilized by the first AP device and a second AP device, a burst duration indication associated with a groupcast burst transmission of the first AP device involving the primary channel, wherein the burst duration indication enables a second AP device to perform communications with at least one client device via a Non-Primary Channel Access (NPCA) primary channel for an amount of time based on the burst duration indication.

15. The method of claim 14, wherein the burst duration indication is included in one of:
a physical layer (PHY) header of at least one physical layer protocol data unit of the groupcast burst transmission; or
a frame body of at least one beacon frame of the groupcast burst transmission.

16. The method of claim 14, wherein the burst duration indication is included in a control frame that precedes a first beacon frame of the groupcast burst transmission.

17. The method of claim 14, wherein the burst duration indication is included in a control frame that is after a first beacon frame of the groupcast burst transmission.

18. The method of claim 14, further comprising:
providing an indicator of the groupcast burst transmission within at least one control frame or within at least one beacon frame.

19. The method of claim 18, wherein the indicator of the groupcast burst transmission is included in a frame control field of a Media Access Control (MAC) header of the at least one beacon frame of the groupcast burst transmission.

20. The method of claim 18, wherein the indicator of the groupcast burst transmission is included in a capabilities information field of at least one beacon frame of the groupcast burst transmission.

21. The method of claim 18, wherein the indicator of the groupcast burst transmission is included in an extended capabilities element of at least one beacon frame of the groupcast burst transmission.

22. The method of claim 14, further comprising:
establishing a multi-AP coordination (MAPC) sub-agreement between the first AP device and the second AP device defines that the first AP device is to provide the burst duration indication for any groupcast burst transmission of the first AP device.

23. The method of claim 14, further comprising:
establishing a multi-AP coordination (MAPC) sub-agreement between the first AP device and the second AP device that defines that the first AP device is to provide the burst duration indication for any groupcast burst transmission of the first AP device that is to exceed a threshold amount of time.

24. A method comprising:
obtaining by a second access point (AP) device via a primary channel utilized by the second AP device, a burst duration indication associated with a groupcast burst transmission of a first AP device involving the primary channel; and
performing, by the second AP device, communications with at least one client device via a Non-Primary Channel Access (NPCA) primary channel, wherein the communications are performed for an amount of time based on the burst duration indication obtained from the first AP device.

25. The method of claim 24, further comprising:
establishing a multi-AP coordination (MAPC) sub-agreement between the second AP device and the first AP device that defines that the first AP device is to provide the burst duration indication for any groupcast burst transmission of the first AP device or for any groupcast burst transmission that is to exceed a threshold amount of time.

26. The method of claim 25, further comprising:
during the amount of time based on the burst duration indication, determining by the second AP device whether the first AP device is performing the groupcast burst transmission involving the primary channel.

27. The method of claim 26, further comprising:
upon the second AP device determining that the first AP device is not performing the groupcast burst transmission involving the primary channel, the second AP device performing, at least one of:
tearing down of the MAPC sub-agreement; or
establishing a new MAPC sub-agreement between the second AP device and the first AP device.

28. The method of claim 26, further comprising:
upon the second AP device determining that the first AP device is not performing the groupcast burst transmission involving the primary channel, the second AP device performing, at least one of:
notifying the at least one client device to ignore any burst duration indication associated with a groupcast burst transmission of a first AP involving the primary channel obtained from the first AP device; or
notifying the at least one client device to ignore any burst duration indication associated with any groupcast burst transmission of any AP involving the primary channel.

29. The method of claim 24, further comprising:
prior to performing, by the second AP device, the communications with at least one client device via the NPCA primary channel, providing, by the second AP device, an authorizing indication receivable by the at least one client device via the primary channel indicating that the second AP device is to perform the communications via the NPCA primary channel, wherein the authorizing indication enables the at least one client device to perform the communications with the second AP device via the NPCA primary channel.

30. The method of claim 24, wherein the burst duration indication is included in one of:
a physical layer (PHY) header of at least one physical layer protocol data unit of the groupcast burst transmission; or
a frame body of at least one beacon frame of the groupcast burst transmission.

31. The method of claim 24, wherein the burst duration indication is included in a control frame that precedes a first beacon frame of the groupcast burst transmission.

32. The method of claim 24, wherein the burst duration indication is included in a control frame that is after a first beacon frame of the groupcast burst transmission.
